(19) United States
(12) Patent Application Publication
(10) Pub. No.: US 2005/0205840 A1
(43) Pub. Date: Sep. 22, 2005

(54) Oxygen scavenging compositions and methods of use

(76) Inventors: William E. Farneth, Wilmington, DE (US); Noel M. Hasty, Wilmington, DE (US); Michael B. Damore, Wilmington, DE (US); Dexter A. Chisholm, Unionville, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/956,843

(22) Filed: Sep. 30, 2004

Related U.S. Application Data
(60) Provisional application No. 60/508,527, filed on Oct. 3, 2003.

(51) Int. Cl. C09K 3/00

(52) U.S. Cl. 252/188.28

(57) ABSTRACT

Oxygen is removed or maintained in a sealed container by electrochemically reducing the oxygen to water using an enzymatic O₂ scavenging system based on a laccase enzyme. Activation of the O₂ scavenging system typically occurs by water (liquid or vapor) adsorption; in preferred embodiments, ascorbate and isoascorbate (and their corresponding acids) are especially advantageous for their dual role as reductant and hygroscopic agent. The capacity of the O₂ scavenging system can be manipulated by altering the concentration of reductant that is included in the O₂ scavenging composition. The O₂ scavenging system can be prepared in a variety of formats (e.g., inks, labels, packets, liners, patches, caps, within the packaging material itself) and is readily produced by apparatuses conventionally used in the industry on a high speed continuous basis.

### FIELD OF INVENTION

The invention relates to methods for controlling, limiting or eradicating harmful oxygen in containers. More specifically, the invention provides an oxygen scavenging system that may be used to control oxygen levels in a sealed environment, comprising an enzyme suitable for oxygen scavenging and a reducing substrate.

### BACKGROUND

There are many products that have limited lifespans in the presence of oxygen (O₂) due to the effects of oxidative deterioration. Such products include e.g., foodstuffs, beverages, cosmetics and personal care products, electronic components/devices and pharmaceuticals. In many cases, these products are flushed with an inert gas during their packaging such that the majority of the O₂ from the container is removed. However, complete removal of O₂ is difficult to achieve at the time of packaging. Some products additionally generate O₂ over time; and, additional O₂ can migrate into the container through the packaging material during storage prior to product use. In food applications, this can lead to problems associated with flavor changes, color changes, photobleaching and microbial growth. Therefore, a need exists for systems that are capable of actively removing O₂ from sealed containers.

A variety of systems have been designed to meet this need, and function by removing O₂ from the void volume or headspace in a container or package. Alternatively, when the system is incorporated into the material used to make the container, the packaging material itself removes O₂ from the container and also serves as a barrier to the ingress of additional O₂. Although a variety of O₂ scavenging systems have been applied in packaging applications, they can all generally be classified into two broad categories consisting of chemical methods and enzymatic methods.

Chemical systems account for the vast majority of approaches. One example is the use of iron powder in packets or sachets that are placed within packages (U.S. Pat. No. 4,992,410). Some other examples include the use of various chemicals incorporated into the packaging materials themselves; e.g., ferrous carbonate (U.S. Pat. No. 6,037,022), ascorbyl palmitate and transition metals (U.S. Pat. No. 6,228,284), ascorbate compounds and transition metal catalysts (U.S. Pat. No. 6,465,065), palladium and other platinum group metals (WO99/05922) and ethylenically unsaturated hydrocarbons and transition metal salts (U.S. Pat. No. 5,648,020). Alternatively, U.S. Pat. No. 6,139,935 incorporates iron directly into a label that is applied to the internal surface of a container. However, despite wide-spread commercial use of such systems, chemical O₂ scavenging systems exhibit a number of problems including, e.g., accidental ingestion of sachets, potential leaching of toxic metals and reaction byproducts, prohibitive cost of components, activation of metal detectors (when used to detect foreign objects within the sealed container), and in one case, a requirement for UV irradiation to activate scavenging. Furthermore, these systems typically suffer from the creation of reactive species during the scavenging chemistry. For example, a number of highly reactive dioxygen-derived intermediates are produced in the transition metal-catalyzed oxidation of ascorbic acid (or its salts), including hydrogen peroxide, superoxide, and other peroxidic intermediates. These species are free radical in nature and can initiate autocatalytic chain reactions (Fabian, I. and V. Csordas, Advances in Inorganic Chemistry, 54:395 (2003) and Davies, M. B., Polyhedron, 11 (3):285(1992)).

Enzymatic systems are also useful as O₂ scavenging systems; and, the most well-known system is based on glucose oxidase. Typically, the glucose oxidase system is comprised of two enzymes: glucose oxidase (EC 1.1.3.4) and catalase (EC 1.11.1.6). Glucose oxidase catalyzes the oxidation of glucose to gluconic acid and converts molecular O₂ to hydrogen peroxide (H₂O₂). Catalase is required to react with the highly reactive and undesirable peroxide [H₂O₂→H₂O+O₂]. This system is effective in removing O₂ from a sealed environment and has been the subject of a number of patents and publications over the years (see, for example, U.S. Pat. No. 2,482,724; U.S. Pat. No. 2,765,233; U.S. Pat. No. 3,016,336; U.S. Pat. No. 4,996,062; WO 91/13556; Andersson et al., Biotech. Bioeng., 78:37 (2002); Lehtonen, 8^{th} Eur. Polymers, Films, Laminations and Extrusion Coatings Conf., Barcelona, Spain, 2001, pp 75-81, TAPPI: Atlanta, Ga.). The production of H₂O₂ remains the principal drawback. And, although catalase can be added to convert the H₂O₂ to H₂O, it must remain active over the lifetime of the glucose oxidase. Catalase is also a highly colored protein which is undesirable in some applications. Finally, glucose oxidase functions only with one reductant (i.e., glucose) and the reaction product (i.e., gluconic acid) lowers pH, resulting in inhibition of both enzymes (i.e., glucose oxidase and catalase).

Another enzymatic O₂ scavenging system that has been disclosed is based on ascorbate oxidase (EC 1.10.3.3) and its substrate, either ascorbate or ascorbic acid. This enzyme offers an advantage over glucose oxidase in that the reduction of molecular O₂ results in H₂O as a reaction product, without production of any reactive intermediates. This system has been proposed for direct incorporation into fruit juices, where naturally available ascorbate can serve as substrate (Matsui et al., Nippon Shokuhin kagaku Kogaku Kaishi. 43:362 (1996)). It has also been disclosed for use in foods where ascorbate has been added to serve as a reductant; or a mixture of powdered enzyme and ascorbate are provided in a sachet type packet that is then activated by dissolving in a liquid medium such as a buffer solution (U.S. Pat. No. 5,180,672). However, despite these improvements over the glucose oxidase O₂ scavenging system, the ascorbate oxidase system suffers from the disadvantage of; (i) requiring a specific substrate (i.e., ascorbate or ascorbic acid), (ii) being highly labile as a system and; (iii) the unavailability of commercial quantities of enzyme.

Laccase represents another enzyme that is capable of reducing molecular O₂ directly to H₂O, without the production of reactive intermediates. Unlike ascorbate oxidase, however, laccase can react with a wide range of substrates. This permits flexibility in formulating a deoxygenating system. Furthermore, laccase has been the focus of considerable development effort for use in industrial processes. As a consequence of the commerical use of laccase, it is commercially available in large quantities.

WO 95/21240 teaches the addition of laccase to beer to reduce haze formation and remove O₂, presumably with the naturally occurring phenolic compounds serving as reductants for laccase. Similarly, WO 96/31133 discloses the use of laccase to deoxygenate processed foodstuffs such as tomato juice, citrus juice or applesauce. Again, naturally occurring reductants were used, although it was suggested that anthocyanins or spices (e.g., paprika) could be added to act as substrates for laccase. U.S. Pat. No. 5,980,956, teaches the use of laccase to deoxygenate oil products such as mayonnaise and salad dressing. The authors noted improvement in deoxygenation rate was found when additional substrate was supplied in the form of citrus juice, mustard, or paprika, but there was an upper limit to how much additional substrate could be added before the product became inedible.

In all of the cases described above, however, the laccase enzyme is mixed directly into the food and all of the oxidation chemistry takes place within the food, which can lead to off-flavors and changes in appearance. The deoxygenating capacity is also limited by the amount of substrate naturally available in the food, or the amount that can be added while maintaining an edible product. Finally, direct addition of laccase requires the food product to be in a largely liquid form (e.g., a juice, puree, or emulsion) to allow reaction between the enzyme and a diffuse substrate. Such an approach would be inoperable with foods such as fresh pasta, meats, or bakery goods.

The Applicants have overcome these deficiencies by developing an enzymatic O₂ scavenging system suitable for reducing the O₂ content within a sealed container. Beneficially, the O₂ scavenging system permits indirect contact between the redox chemistry of the enzyme and its substrate and the contents of the sealed container, by use of a functional barrier. The O₂ scavenging system described herein can be prepared in a variety of formats (e.g., label, packets, liners, patches, caps, within the packaging material itself). Activation of the O₂ scavenging system typically occurs by water (liquid or vapor) adsorption; and, in preferred embodiments, ascorbate and isoascorbate (and their corresponding acids) are especially advantageous for their dual role as reductant and hygroscopic agent, thereby allowing self-activation of the O₂ scavenging system within the sealed container.

### SUMMARY OF THE INVENTION

The invention involves an oxygen scavenging system comprised of a laccase enzyme and a reducing substrate that is useful for the removal of oxygen from various containers and packages. The scavenging system is not in direct contact with the contents of any container or package but is sequestered by a functional barrier that is permeable to oxygen. In some embodiments the enzyme may be provided in inactive form and activated upon introduction to the container or package.

Accordingly the invention provides an oxygen scavenging system comprising:
a) an oxygen scavenging composition comprising:
   i) an effective amount of laccase enzyme; and
   ii) an effective amount of a reducing substrate; and
b) a functional barrier permeable to oxygen.

The laccase enzyme may be initially provided in inactive form where the enzyme is inactivated by drying or freezing.

Optionally the scavenging composition of the invention may contain additional materials such as a polymeric binder, a buffer, a hygroscopic agent and an inert filler.

In another embodiment the invention provides a composition comprising:
a) a material selected from the group consisting of: wood pulp filter paper, glass fiber filter paper, paperboard, fabric, nonwoven fabrics, polymer films and label stock, polymeric materials, a mat, a card, a disk, a sponge, polymeric foam; and
b) a matrix comprising the oxygen scavenging system of the invention.

In another embodiment an ink is provided comprising the oxygen scavenging system of the invention. Similarly the invention provides sealed containers comprising the oxygen scavenging system of the invention.

Labels comprising the oxygen scavenging system of the invention and having a structure as shown in FIG. 1 are additionally provided.

In a preferred embodiment the invention provides a method for removing oxygen from a sealed container comprising:
a) providing a sealed container having contents;
b) providing an oxygen scavenging system comprising:
   i) an oxygen scavenging composition comprising:
      1) an effective amount of laccase enzyme; and
      2) an effective amount of a reducing substrate;
   ii) a functional barrier permeable to oxygen;
   wherein the functional barrier serves to sequester the contents of the container from the oxygen scavenging system; and
c) contacting the contents of the sealed container with the oxygen scavenging system whereby oxygen is removed from the sealed container.

Typical contents for such a container may include for example foods, beverages, electronic components, cosmetics and personal care products, and pharmaceuticals.

In an alternate embodiment the invention provides an oxygen scavenging system comprising:
a) an oxygen scavenging composition comprising:
   i) an effective amount of ascorbate oxidase enzyme; and
   ii) an effective amount of a reducing substrate; and
b) a functional barrier permeable to oxygen;
wherein the ascorbate oxidase is in an inactive state and wherein the inactivated oxygen scavenging composition is activated by a method selected from the group consisting of: thawing and adsorption of water vapor.

### BRIEF DESCRIPTION OF THE FIGURES

FIG. 1 is a schematic diagram showing a label structure comprising the O₂ scavenging system of the invention.

FIG. 2 is a graph depicting the effect of the scavenger on the headspace O₂ partial pressure.

### DETAILED DESCRIPTION OF THE INVENTION

The present invention is directed to a process to remove oxygen (O₂) from a sealed container wherein: 1.) an O₂ scavenging system is provided, comprising an enzyme and a reducing substrate; and 2.) the system is in indirect contact with the contents of the sealed container. The present invention also provides a process to prevent O₂ from entering a sealed container made from a packaging material, wherein: 1.) the packaging material comprises an O₂ scavenging system comprised of an enzyme and a reducing substrate; 2.) the system is in indirect contact with the contents of the sealed container. The invention is also directed to articles containing the system described above.

The present inventions can be used in many situations where O₂ needs to be removed from a container. Such situations can range from preserving a variety of electronic components/devices (e.g., O₂-sensitive DVDs), to inerting aircraft fuel tanks, to preserving specific pharmaceutical compositions, to generating O₂-free atmospheres for culturing anaerobic microorganisms, to preserving cosmetics and personal care products (e.g., hand creams) from degradation. However, due to the food-safe nature of laccase and ascorbate oxidase, and certain reductants, the invention is particularly attractive for use in food/beverage packages as a mechanism to preserve the food product. The presence of O₂ in a food package causes spoilage of food, which may be due to the oxidation of the ingredients in the food (e.g., fats and vitamins) or to the growth of O₂-requiring microorganisms (e.g., aerobic bacteria, yeasts and molds) within the food or on its surface. Thus, development of O₂ scavenging systems for packaging is critical for manufacturers within the food industries, as it can substantially increase the shelf-life of food products and ensure that the quality of such products remains unchanged during the shelf-life.

Advantages incurred by use of the O₂ scavenging systems of the invention herein include: use of food-safe components, easily applied water-based formulations, and the ability to apply the O₂ scavenging system in thin layers. Additionally, the O₂ scavenging systems are characterized as non-metallic (thus enabling sealed containers to be screened for inclusion of foreign objects via metal detectors) and microwave safe.

### DEFINITIONS

The following definitions may be used for the interpretation of the claims and the specification.

The terms “sealed container”, “sealed environment” and “package” refer to a container or environment that defines an interior space designed to hold a product of any type and that is substantially impermeable to O₂. The container may be in the form of a pouch, bag, can, tank, barrel, silo, jar, box, envelope, bottle, or sealed wrapping (although these examples are not intended to be limiting). The contents can be solid, liquid, gaseous or mixtures thereof, and can be material designed to be consumed (e.g., a food, beverage or pharmaceutical product), electronic components or devices, microorganisms, cosmetics and personal care products, oxygen-free atmosphere and fuels. Typically, the container is flushed with an inert gas prior to sealing.

The term “inert gas” means a gas that is un-reactive with respect to the contents of the package or container, as opposed to meaning a gas that is un-reactive under all circumstances. Thus, an inert gas within the context of the invention herein refers to, for example: nitrogen, helium, argon, carbon dioxide or a mixture thereof.

The term “O₂ scavenging system” refers to an enzymatic system comprising an O₂ scavenging composition that is: 1.) capable of actively removing O₂ from a sealed container; and 2.) in indirect contact with the contents of the container. The system typically functions by either removing O₂ from the void volume or headspace in the sealed container; or, when the system is incorporated into the material used to make the container, the packaging material itself removes O₂ from the container and also serves as a barrier to the ingress of additional O₂.

The terms “remove O₂ ” and “O₂ scavenging” refer to a process whereby molecular O₂ within a sealed container is converted to H₂O by a reduction reaction. The result of this process may be: 1.) an overall decrease in the amount of molecular O₂ in the container; 2.) no net change in the amount of molecular O₂ in the container; or, 3.) an increase in the amount of molecular O₂ in the container of smaller magnitude than would be observed in the absence of the O₂ scavenging system of the invention. In all cases, the amount of molecular O₂ in the container will be dependent on the rate of O₂ scavenging, the capacity of the O₂ scavenging system, the rate of O₂ ingress into the sealed container and the amount of O₂ that is initially present within the sealed container.

The term “O₂ scavenging composition” refers to a composition that consists essentially of an enzyme capable of reducing molecular O₂ to water, using a suitable reductant. Optionally, the O₂ scavenging composition may also include e.g., buffers, polymeric binders, inert fillers and hygroscopic and/or deliquescent agents.

The term “laccase” refers to a multi-copper oxidoreductase enzyme (EC 1.10.3.2) that catalyzes the four-electron reduction of O₂ to H₂O with the concomitant one-electron oxidation of a substrate. Laccase is the preferred enzyme for use in the O₂ scavenging compositions of the present invention.

The term “ascorbate oxidase” refers to a multi-copper oxidoreductase enzyme (EC 1.10.3.3) that catalyzes the four-electron reduction of O₂ to H₂O with the concomitant one-electron oxidation of a substrate (i.e., either ascorbate or ascorbic acid).

The terms “reducing substrate”, “substrate” and “reductant” are used interchangeably herein and each refers to a material that is capable of acting as a source of electrons for the enzyme included within the O₂ scavenging composition of the invention.

The term “hygroscopic” refers to a compound in solid phase that has the ability to capture water molecules from the gas phase. Thus, a hygroscopic compound will readily absorb moisture from its surroundings. A related term is “deliquescent”, defined herein as having a tendency to form an aqueous solution or to dissolve and become liquid by the absorption of moisture from the air. In preferred embodiments of the invention, the reductant is itself hygroscopic and/or deliquescent.

The term “functional barrier” refers to a material whose function is to prevent direct contact between the O₂ scavenging composition and the contents of the sealed container. The barrier should be permeable to O₂ and capable of serving as a component of a repository for, or containing, the O₂ scavenging composition. Typically, functional barrier materials will include polymeric materials in the form of films or matrices. In preferred embodiments, the functional barrier will meet the requirements of the Food and Drug Administration for food contact, when the contents of the sealed container are for human consumption as a food, beverage, or pharmaceutical product (see 21 CFR §177.1390).

The terms “inactivation” or “inactivated” refer to a state when the enzyme of the O₂ scavenging composition or O₂ scavenging system is not capable of scavenging O₂. Typically, this inactivation occurs by drying or freezing the enzyme, as a means to preserve its enzymatic activity and prevent premature activation of the system, prior to the desired commencement of O₂ scavenging within a sealed container.

The terms “activation” or “activated” refer to a state when the enzyme of the O₂ scavenging composition or O₂ scavenging system is capable of scavenging O₂, as described in the invention herein. The process of activation requires water to rehydrate the system, typically by direct contact of liquid water, by adsorbing water vapor or by thawing. Although well known in the art, for clarity, the term “water vapor” will be defined herein as water in gaseous form, arising either through evaporation of liquid water or sublimation of solid ice. The amount of water vapor present in a given air sample may be measured in a number of different ways, involving such concepts as absolute humidity, mixing ratio, dewpoint, relative humidity, specific humidity, and vapor pressure.

The term “ink” refers to a composition that comprises a colorant in combination with a solvent, an enzyme capable of using molecular O₂ as substrate, a suitable reductant, a polymeric binder and a thickening agent. The preferred solvent is water. Optionally, the ink may also include e.g., buffers, inert fillers, pigments and hygroscopic agents. The ink may be applied to a material by various methods, including spreading by wire-wound coating rod, rotary screen printing, flexographic printing, gravure printing and ink jet printing.

The O₂ Scavenging System: An Overview

The minimum components of the O₂ scavenging composition herein are an enzyme capable of reducing molecular O₂ directly to water and an appropriate reducing substrate. Generally, the enzyme is present in relatively low concentrations, while the concentration of the reducing substrate is much greater and is determined according to the amount of O₂ scavenging capacity that is required of the O₂ scavenging system (e.g., about two moles of a typical two-electron reducing substrate are required to reduce one mole of molecular O₂ to H₂O). The O₂ scavenging composition, particularly in the form of a homogeneous liquid solution, can be applied to a surface in a variety of manners (e.g., printing, adsorption, absorption, etc.). Subsequently, the surface to which the scavenging composition has been applied is typically permitted to dry such that the system assumes an “inactive” state. Upon seclusion of the O₂ scavenging composition behind a functional barrier, the complete O₂ scavenging system may then be incorporated into a container. The O₂ scavenging system will self-activate within a sealed container having moisture when the reductant adsorbs water and O₂ scavenging commences in the highly concentrated solution. Although the scavenging rates achieved according to the invention herein are infinitely customizable (i.e., based on the temperature, humidity, concentration of components within the O₂ scavenging composition, surface area, etc.), in one embodiment the O₂ scavenging system has been utilized to reduce the O₂ concentration in a 900 mL container from 20.9% to 0% in 40 hours.

An O₂ Scavenger: Laccase

Laccases (E.C. 1.10.3.2) are a group of multi-copper oxido-reductases (Systematic Name: Benzenediol:oxygen oxidoreductase). These enzymes are capable of removing electrons from a wide range of substrates. In all reactions, however, the enzyme performs a four-electron reduction of molecular O₂ to form H₂O. For a general review of laccases, see for example: Dawson, C. R. and Tarpley, W. B. The copper oxidases. In: Sumner, J. B. and Myrback, K. (Eds.), The Enzymes, 1^{st} ed., vol. 2, Academic: New York, 1951, p 454-498; Malmstrom, B. G. et al., Copper-containing oxidases and superoxide dismutase. In: Boyer, P. D. (Ed.), The Enzymes, 3^{rd} ed., vol. 12, Academic: New York, 1975, p 507-579; Mayer, A. M. and Harel, E. Phytochem. 18:193-215 ((1979); Nakamura, T. Biochim. Biophys. Acta 30:44-52 and 538-542 (1958); Reinhammar, B. and Malmstrom, B. G. “Blue” copper-containing oxidases. In: Spiro, T. G. (Ed.), Copper Proteins, Wiley: New York, p 109-149 (1981). For insight into the crystal structure of a laccase, see, for example, Bertrand, T. et al. (Biochemistry. 41(23):7325-7333 (2002)).

Laccases are widely distributed throughout nature, occurring in plants, fungi, yeasts and bacteria; however, the best known laccase producers are of fungal origin, since these enzymes are particularly well-studied due to their natural role in both the polymerization and depolymerization of lignin. As such, some fungal laccases suitable for the purposes of the present invention herein include (but are not limited to) those isolated from Ascomycetes and Basidiomycetes. More specifically, illustrative sources of fungal laccases include those from: Aspergillus, Neurospora, Podospora, Botrytis, Collybia, Fomes, Lentinus, Pleurotus, Trametes, Rhizoctonia, Coprinus, Psaturella, Myceliophthora, Schytalidium, Polyporus, Phlebia, Coriolus, Hydrophoropsis, Agaricus, Cascellum, Crucibulum, Myrothecium, Stachybotrys and Sporormiella. Most preferred are Trametes versicolor, T. villosa, Myceliophthora thermophilia, Stachybotrys chartarum, Coriolus hirsutus and C. versicolor. Most preferred are commercially available laccases availabiel from sources such as Wacker Chemie (München, Germany; T. versicolor), Novozymes (Franklinton, N.C.; M. thermophilia), Genencor (Palo Alto, Calif.; S. chartarum), Sigma-Aldrich (St. Louis, Mo.; C. versicolor) and SynectiQ (Dover, N.J.; C. hirsutus).

The source of laccase is not limiting to the invention herein. Thus, although fungal laccases are preferred, laccases can also be obtained from transgenic yeasts (e.g., Pichia, Saccharomyces and Kluyveromyces), transgenic fungi (e.g., Aspergillus, Trichoderma or Chrysosporium) and transgenic plants that serve as production hosts to express laccase genes cloned from other organisms (e.g., of fungal origin). Additionally, laccase may be produced from a variety of bacteria (e.g., Escherichia, Bacillus and Streptomyces).

Additionally non-native laccases may also be used in the invention herein. These modified laccases can be obtained by traditional mutagenesis (e.g., chemical, UV) or directed evolution methods (e.g., in vitro mutagenesis and selection, site-directed mutagenesis, error prone PCR, “gene shuffling”), wherein the techniques are designed to alter the amino acid sequence of the protein with the objective of improving the characteristics of the laccase. Examples of improvements would include altering substrate specificity or increasing the stability of the native enzyme.

Although the particular source of the laccase introduced into the O₂ scavenging system is not critical to the invention, considerations for choosing a specific laccase include: 1.) sufficient activity/rate with substrate; 2.) the stability of the enzyme over time; 3.) the substrate activity spectrum of the laccase; 4.) the pH and/or temperature optimum of the laccase; and 5.) cost.

The amount of laccase required in the present invention depends on a number of factors. For example, one must consider:
1. Package parameters (e.g., package volume, initial O₂ concentration, ambient temperature, rate of O₂ ingress, desired rate of scavenging, desired residual O₂ concentration); and,
2. Enzyme related factors (e.g., the molecular weight and specific activity of the particular laccase used, longevity of the enzyme's activity).
   These factors can combine to result in a very large range of effective enzyme amounts, typically 1-10,000 mg per mole of reductant. In preferred embodiments, however, the enzyme is generally present at an amount of about 1-200 μg/cm² within a coating.
   Reducing Substrates for Laccase

Reducing substrates are herein defined as compounds that are capable of donating electrons to the type 1 copper site of laccase. Laccase is well known to be able to accept electrons from a wide range of phenolic molecules, as well as some small non-phenolic molecules. Although laccase can accept electrons from a variety of molecules, substrate activity can vary broadly.

Reductant activity can be tested by mixing laccase and a candidate reductant in a sealed container and measuring the loss of O₂. Based on measurements such as this, for example, it has been determined that typically:
Butylated hydroxyanisole (BHA) is an excellent substrate, but similar molecules such as butylated hydroxytoluene (BHT) and tertiary-butylated hydroquinone (t-BHQ) are less preferred as substrates.
Ascorbic acid (and its salts) and isoascorbic acid (and its salts) are good substrates, but their activity is pH dependent.
   Typical substrates are low molecular weight compounds that are efficient electron donors to laccase such as syringaldazine or 2,2′-azinobis(3-ethylbenzothiazoline-6-sulfonate) (ABTS). Other substrates for use with foods are compounds Generally Recognized as Safe (GRAS; see 21 CFR §182) by the Food and Drug Administration; non-limiting examples include ascorbic acid, sodium ascorbate, calcium ascorbate, sodium sulfite, propyl gallate, ethoxyquin and butylated hydroxyanisole. In a preferred embodiment, however, the reducing substrate is ascorbic acid, calcium ascorbate or sodium ascorbate, or combinations therewith.

The capacity of the O₂ scavenging system of the present invention is determined by the amount of reducing substrate available, with about two moles of a typical two-electron reducing substrate required to reduce one mole of molecular O₂ to H₂O. Of course, the exact amount of reductant is not critical, but it is best of have at least the above amount present. For example, about 3 g of sodium abscorbate (MW 198) or BHA (MW 180) would be required to remove all the O₂ from 1 L of air at 25° C.; and, one skilled in the art could determine proportional amounts of reductant that would be required for more or less O₂ scavenging capacity. In preferred embodiments, when sodium abscorbate is used as the reductant, it is typically used at a loading of about 1-20 mg/cm² within a coating.

If the reductant is water soluble, it can be dissolved in the same buffer as the enzyme to prepare a liquid O₂ scavenging composition. If the reductant is not water soluble, however, it can be dissolved in a suitable non-polar solvent (e.g., vegetable oil, polypropylene glycol) and mixed with the aqueous enzyme solution to form an emulsion. In this case, it may be desirable to also add an amphiphilic substance (e.g., lecithin) to help stabilize the emulsion. One skilled in the art would readily be able to identify other amphiphilic compounds that would not interfere with the ability of the system to scavenge O₂ and would be able to determine the appropriate concentration of material necessary to accomplish its intended purpose.

An Alternative O₂ Scavenger: Ascorbate Oxidase

Ascorbate oxidases (E.C. 1.10.3.3) are a group of multi-copper oxido-reductases (Systematic Name: L-ascorbate:oxygen oxidoreductase). These enzymes are capable of removing electrons from either ascorbate or ascorbic acid; in both reactions, however, the enzyme performs a four-electron reduction of molecular O₂ to form H₂O. For a general review of ascorbate oxidases, see for example: Dawson, C. R., K. G. Strothkamp and K. G. Krul. Ann N Y Acad Sci. 258:209-220 (1975)).

The best known ascorbate oxidases originate from plants, and, those suitable for the purposes of the present invention herein include (but are not limited to) those isolated from tobacco, soybean, cucumber, squash plants, etc. More preferred, however, are those thermally stable ascorbate oxidases that are isolated from fungi, and in particular, from species of the genus Acremonium (e.g., see U.S. Pat. No. 5,180,672). Considerations affecting the selection of a particular ascorbate oxidase are similar to those taught above for laccase, as are the factors affecting the amount of enzyme required.

Buffers and Polymeric Binders to Optionally Include in the O₂ Scavenging Composition

The enzymatic activity of laccase and ascorbate oxidase can be enhanced by maintaining the pH of the reaction mixture within a suitable range. This pH range can vary between O₂ scavenging enzymes from different sources. However, once an optimal range has been determined for a particular enzyme, buffers can be included in the O₂ scavenging composition to maintain this pH. The ratio of ascorbic acid to ascorbate can also be used to modulate pH, when these compounds are used as reductants.

In addition to the enzyme and reductant (and optionally a non-polar solvent and amphiphilic substance), it may be advantageous to include a binder in the O₂ scavenging composition. The binder beneficially functions to improve the coating performance (e.g., uniformity in distribution and ability to bind to a surface), viscosity control, and solution stability of the O₂ scavenging composition. Non-limiting examples of suitable binders in the invention herein are: 1.) dispersions of neoprene, styrene butadiene rubber, Surlyn®, vinyl acetate ethylene copolymer and natural rubber; and 2.) solutions of poly vinyl alcohol, carboxymethyl cellulose, hydroxypropyl methyl cellulose and soy protein.

In preferred embodiments, polymer dispersions have less utility than solutions, since coagulation can occur within minutes to days after the mixture is prepared. Additionally, the O₂ scavenging system's requirements for high ascorbate content (i.e., up to about 25 weight %) and maintenance of a pH close to neutral in the final coating solution restricts the use of polymer dispersions. Solutions of poly vinyl alcohol perform better as binders, but they often form gels. Thus, carboxymethyl cellulose or hydroxypropyl methyl cellulose are most desirable for use as binders, since they permit formation of stable (e.g., 1-30 days), high viscosity solutions at low levels of enzyme (e.g., about 0.02 to 0.2 weight %) and tolerate the required amount of ascorbate (supra). This high viscosity also leads to improved coating performance of the O₂ scavenging composition, e.g., when using screen printing to coat the O₂ scavenging composition onto a packaging film.

Hygroscopic Agent

Hygroscopic agents may optionally be included within the O₂ scavenging composition. These agents (e.g., fructose, silica gel, or polyvinyl alcohol) are valued for their water adsorbing properties, as they are useful in the process of “activating” a dehydrated O₂ scavenging system comprising an O₂ scavenging composition. When included within the composition, the hygroscopic agent is incorporated in an amount of about 1-50% by weight of the total composition.

Alternatively, sodium and calcium salts are inherently hygroscopic. Thus, ascorbate can serve as a hygroscopic agent in addition to its role as substrate. In some instances, ascorbates can be advantageously mixed with other reducing agents. For example, a non-hygroscopic reductant that e.g., demonstrates high activity with a preferred enzyme or enhances the coating characteristics of a O₂ scavenging system may be used in combination with ascorbate salts in a particular O₂ scavenging composition. Thus, in one embodiment, the O₂ scavenging composition is comprised of laccase in an amount by weight of about 0.01% to 10%, sodium ascorbate in an amount by weight of about 10% to 99.99% and BHA in an amount by weight of about 10% to 99%.

Functional Barriers

As defined above, the purpose of the functional barrier is to ensure that the O₂ scavenging composition is sequestered in such a manner that it does not directly contact the contents of the sealed container. The functional barrier should be permeable to O₂, such that O₂ within the headspace of the sealed container may diffuse through the functional barrier and thereby react with the O₂ scavenging composition.

Typically, functional barrier materials will include polymeric materials in the form of films or matrices. Suitable polymer materials that could be used, as well as details concerning each polymer's O₂ permeabilities, are found in: 1.) “Permeability Properties of Plastics and Elastomers, 2^{nd} Ed.”, Liesl K. Massey, ed, Plastics Design Library, Norwich: N.Y. (2003); 2.) “Barrier Polymers and Structures”, Koros ed, ACS Symposium Series, American Chemical Society: Washington D.C., pp 111 & 163 (1990); and, 3.) Stannett, Poly Eng & Sci, 18(15):1129-1134 (1978). Thus, for example, a non-limiting list of polymers suitable in the present invention include: polyacrylonitrile, polymethacrylonitrile, polyvinylidene chloride, polyethylene, terephthalate, Nylon 6®, polyvinyl chloride, polyethylene, cellulose acetate, cellulose acetate butyrate, cellulose diacetate, polycarbonate, polystyrene, Neoprene®, Teflon®, poly 4-methyl pentene-1 and poly dimethyl siloxane. Of course, any polymer that is inert to the O₂ scavenging system and the contents of the sealed container, and that has sufficient permeability to O₂, can be used in the invention herein.

Alternatively, air itself may serve as an appropriate functional barrier when there is no possibility of direct contact between the scavenging composition and the contents of the sealed container.

One must of course consider the specific application in which the O₂ scavenging system is to be used, prior to selection of a specific functional barrier. For example, in some situations, a material that would only allow water vapor to pass through the material would be required to enable activation of the system, since a material that would allow liquid water to pass through the material would not be a suitable functional barrier because the O₂ scavenging composition and the contents of the sealed container could leach through a shared aqueous solution.

Application of the O₂ Scavenging System to a Surface

The O₂ scavenging composition may be applied to a number of different surfaces, including for example: wood pulp filter paper, glass fiber filter paper, paperboard, fabric, nonwoven fabrics, polymer films and label stock. In one embodiment of the present invention, coatings on filter paper are preferred to coatings on polymer films (e.g., Mylar®), as they permit greater O₂ scavenging rates/hour. This is hypothesized to result due to differences in surface area, wherein those surfaces having greater porosity (and, therefore, surface area) enable higher rates of O₂ transfer. To compensate for this difference, it is possible to include a filler with high surface area (e.g., microgranular cellulose, ground molecular sieve, carbon black, graphite, clay, wood pulp, activated carbon) in the O₂ scavenging composition coating, when it is applied to a surface other than a filter paper.

The particular method of application of the O₂ scavenging system is not limiting to the invention herein, and, one skilled in the art of packaging would readily be able to determine the most suitable methodology for application of the O₂ scavenging composition to a surface, depending on the specific packaging application and commercial methods of container preparation. Suitable methods for application of the O₂ scavenging system include, for example: spreading by wire-wound coating rod, rotary screen printing, flexographic printing, spraying, blotting, dipping, coating and ink jetting, and other methods known to one of skill in the art. In any scenario, however, one must ensure that a suitable amount of the O₂ scavenging system is applied to the desired surface to enable sufficient O₂ scavenging within the sealed container in which the system is to be used, as defined according to the particular application (e.g., desired rate of scavenging, maximum acceptable O₂ concentration, etc.).

Application of a Homogeneous O₂ Scavenging Composition

The O₂ scavenging composition can be applied to a surface as a homogeneous mixture, wherein the enzyme, reductant and any other optional components are first prepared as an intimate admixture. This mixture can take the form of a solid or a liquid. For example, in many embodiments, a liquid solution comprising the O₂ scavenging composition can be used as an ink, applied by a gravure roller.

Application of a Non-Homogeneous O₂ Scavenging Composition

Alternatively it is possible to prepare an O₂ scavenging system whereby individual components of the O₂ scavenging composition are distinct from one another or where individual components are applied to the surface at different times. In the former case, it is possible to prepare a binary system whereby the enzyme is present on e.g., a printed label, and, the reductant is present on e.g., a functional barrier film that is used to cover the label. The O₂ scavenging system is not fully assembled until the film and label are laminated together, such that the enzyme and reductant are in close proximity to one another and are able to chemically react. In the latter case, whereby individual components of the O₂ scavenging composition are applied to the surface at different times, it is possible to first apply a layer of enzyme to a surface, allow the enzyme to dry on the surface, and then apply a coating of reductant on top of the enzyme-coated surface.

Inactivation of the O₂ Scavenging System

Advantageously, the O₂ scavenging systems and compositions of the present invention have great stability, when stored in a dried or frozen state. This permits preservation of the enzymatic activity and prevention of premature activation of the system, prior to the commencement of O₂ scavenging within a sealed container. For example, when the O₂ scavenging composition is applied as ink, the ink is typically allowed to dry prior to its use as an O₂ scavenger (most preferably, with drying occurring at ambient temperature under reduced pressure with nitrogen purge, although these conditions are not to be construed as limiting). Likewise, the Applicants have determined minimal loss in enzymatic activity of filter paper strips coated with the O₂ scavenging system and stored in a dry atmosphere for a period of about 11 months (although this time of storage is not intended to be limiting). Alternatively, the O₂ scavenging compositions of the invention may be preserved by storage in a freezer for indefinite periods.

It is important to note that the O₂ scavenging compositions may be stored prior to their application onto a surface, following their application onto a surface, or as a complete O₂ scavenging system that is present in a sealed container.

Although the ability to dry or freeze the O₂ scavenging compositions and systems is considered to be an it is not a requirement of the invention that the O₂ scavenging composition be dried or frozen before its use. For example, in some applications, it may be desirable to apply the O₂ scavenging composition in liquid form directly to a surface within a container, immediately seal the container, and achieve suitable O₂ scavenging.

“Activation” of the O₂ Scavenging System Within a Sealed Container

When the O₂ scavenging composition of the O₂ scavenging system has been dried for some period of time to preserve enzymatic activity and prevent premature activation of the system, it is necessary to “activate” the composition immediately prior to (or soon after) its introduction into the sealed container where O₂ scavenging is desired. This process of activation requires water to re-hydrate the system. In one embodiment, liquid water can come into direct contact with the O₂ scavenging composition or by thawing of a frozen O₂ scavenging composition.

Typically, the O₂ scavenging system is reactivated by adsorbing moisture from the vapor within the sealed container or water vapor passing through a functional barrier (i.e., a polymer membrane). In this case, it is hypothesized that the system is activated when water is adsorbed by a hygroscopic component in the scavenging composition, effectively re-hydrating the O₂ scavenging enzyme, and mixing the enzyme and reductant, thus providing a concentrated fluid medium in which the reaction can occur. The timing of activation will of course depend on a variety of factors, including:
Moisture content/relative humidity of the sealed container. Specifically, the greater the moisture content of the container, the sooner O₂ scavenging will commence.
The surface on which the O₂ scavenging composition is deposited. The rate of activation is affected by the particular surface on which the O₂ scavenging composition is deposited, the loading of the reductant and the ambient temperature.
The nature of the hygroscopic agent. In a preferred embodiment, it is possible to control the activation and storage properties of the O₂ scavenging system by careful selection of the cationic component of a reductant salt, since different salts are deliquescent over different ranges of relative humidity.
Water vapor permeability of the functional barrier. As is well known in the art, functional barriers have different water vapor permeabilities.

Additionally, it may be useful to include additional hygroscopic agents (other than the reductant itself) within the O₂ scavenging composition, as a means to accelerate the activation process.

Alternatively, it may be desirable to activate the system in ways other than by water vapor adsorption. For example, hydrated enzyme carried on a paper label may be laminated to dry reductant on a functional barrier. This would permit mixing and activation of the O₂ scavenging system. Conversely, the O₂ scavenging composition could be exposed to microwave radiation so as to release bound water, thereby enabling activation of the system.

### Structural Embodiments of the O₂ Scavenging System

Many approaches can be used to construct packaging for foodstuffs and other materials using the O₂ scavenging system described herein. Selection of a particular format can be determined based on the needs of the packager. However, in all cases, the present invention contains enzyme (i.e., either laccase or ascorbate oxidase) and a suitable reductant within an O₂ scavenging composition, wherein the composition is isolated from the contents of the container by use of a functional barrier. This is advantageous as:
1.) Direct contact between the O₂ scavenging enzyme and some package contents such as food, juice, or pharmaceuticals can result in accelerated oxidation of the contents due to the enzymatic activity of the laccase or ascorbate oxidase; and
2.) Direct contact between the concentrated reductant and the contents of the container can lead to flavor or color changes.
   A variety of formats suitable for use with the present system are discussed in detail below, however these examples are not intended to be limiting to the invention herein. One skilled in the art of packaging would readily be able to adapt the O₂ scavenging system to a variety of other packaging needs, based on the teachings herein.
   Incorporation Within the Walls of the Sealed Container

A deoxygenated product stored in a container (e.g., plastic or coated paperboard) is frequently subject to re-oxygenation as O₂ gradually permeates through the walls of the container over time. Certain “high O₂ barrier polymers” have been developed to counteract this (e.g., nonwoven fabrics, polymer films.). However, they add expense and complexity to containers and are not fully effective. Thus, in one embodiment of the present invention, this particular problem in the existing art is overcome by incorporation of the O₂ scavenging composition directly into packaging materials upon their production (e.g., laminated films, coated films, laminated paperboard, extrusion coated paperboard).

Specifically, when the O₂ scavenging system is incorporated within the wall of the sealed container, the container wall may be a layered construction (e.g., co-extruded, extrusion-coated, coated, laminated) that is optionally bonded with adhesives. The interior (e.g., food-contact) layer is a functional barrier, whose function is to prevent direct contact between the O₂ scavenging composition and the contents of the container and permit diffusion of O₂ from the headspace of the sealed container through the functional barrier so that it may react with the O₂ scavenging composition. The functional barrier may be separated from the exterior layer of the sealed container by any number of layers, where no limitation to shape, degree of flexibility, thickness, or number of layers in the final construction should be construed.

To achieve the multilayered construction described above, the O₂ scavenging composition may be incorporated into a variety of polymers and coated or laminated by any method known in the art that does not degrade the O₂ scavenging system. When the O₂ scavenging composition of the present system is incorporated within the packaging material itself, the result is an effective barrier to the entry of external O₂. This feature can be used to augment or replace the high barrier polymers typically used to package O₂ sensitive products.

For example, one method to produce a packaging material of the invention herein would be to coat and dry an O₂ scavenging composition onto paperboard. In one embodiment, a solution comprising the O₂ scavenging system is applied by a gravure roller and the coated paperboard is then dried in a stream of nitrogen. One side of the resultant paperboard is extrusion coated with low-density polyethylene (“LDPE”, a suitable functional barrier), while the reverse face of the paperboard is coated with a high O₂ barrier layer (e.g., ethylene vinyl alcohol copolymer), combined with tie layers and other polymer layers as desired to produce a multilayer packaging material. The LDPE layer is ultimately in contact with the liquid contents of the sealed container, while the O₂ barrier layer is on the outside of the container facing the atmosphere. A container constructed in this manner would possess the ability to remove internal O₂, while also providing an enhanced barrier to O₂ ingress.

In another embodiment, the O₂ scavenging composition can be combined with a carrier polymer matrix and applied to a foil laminate substrate. The polymer matrix may be derived from a variety of polymers and formulated as a dispersion, latex, emulsion, plastisol, dry blend, or solution. After the matrix is applied, it is dried to stabilize the reducing activity and a final lamination of LDPE is applied that would be suitable for contact with the product to be packaged within the sealed container (wherein the LDPE serves as the functional barrier). Thus, construction of a package by this methodology would permit production of a laminated material useful in forming e.g., pouches or beverage boxes. Similarly, the O₂ scavenging composition can be combined with a carrier polymer matrix and applied to multicoated paperboard, then coated with a layer of polymer (e.g., LDPE). Such a material would also be useful in making containers for juices and other liquids (e.g., a jug, carton).

An Insert Within the Sealed Container

Optionally, the components of the O₂ scavenging system will be incorporated into an insert (e.g., a pouch, sachet, envelope, canister, vial, adhesive patch, label, gasket, lid, cap, card, liner, etc.) that is then placed within the container. This insert permits O₂ transfer to occur and thereby enables O₂ scavenging. A functional barrier prevents direct contact between the O₂ scavenging system and the contents of the container. The specific characteristics of the insert and its placement within the container to be sealed are varied, as will be demonstrated below.

1. A Pouch, Sachet, Envelope, Canister or Vial

Specifically, the O₂ scavenging composition can be coated or adsorbed onto a surface and then the O₂ scavenging system can be enclosed within a porous self-enclosed insert that is placed, positioned or affixed anywhere within the container to be sealed. Although many different embodiments will be obvious to one of skill in the art of packaging, the following examples are illustrative. Specifically, a liquid or solid O₂ scavenging composition may be applied to:
a mat, card or disk composed of fibers, such that the composition is contained within the interstices of the fibers;
a sponge or polymeric foam, wherein the composition is contained within the pores of the foam;
a granular or particulate matrix, wherein the matrix can be derived from natural polymers (e.g., cellulose), synthetic polymers, clays, high surface area metal oxide particles, or combinations thereof.
   After application of the O₂ scavenging composition to any of the surfaces above, the composition may optionally be dried or frozen to preserve activity. Subsequently, the wetted, dried, or frozen fibrous material, sponge or matrix may then be enclosed within an insert. The insert can be of any configuration (e.g., a pouch, sachet or envelope made of an O₂ permeable polymeric sheet or film; a canister or vial), wherein at least one functional barrier exists that separates the O₂ scavenging composition from the contents of the container. The insert containing the O₂ scavenging composition can then optionally be dried or frozen to preserve activity, or it may be placed, positioned, or affixed anywhere within the container to be sealed. Following enclosure within the container and sealing, the O₂ scavenging system can be frozen to preserve activity.

2. A Patch or Label

In some embodiments, the O₂ scavenging system may take the form of a patch or label that: 1.) is physically attached to the container and 2.) prevents easy removal of the system from the container by the consumer. In both cases, the functional barrier may exist on only a single face of the structure (i.e., the surface in contact with the contents of the container to be sealed), which is to be distinguished from the self-enclosed pouch, sachet, envelope, canister or vial that was described above.

Specifically, a label or patch is expected to be particularly suitable for use in containers comprising a non-liquid food product (e.g., fresh pasta, meat). The O₂ scavenging composition can be coated or adsorbed onto a surface, and can be used moist, or can be dried or frozen to preserve activity. The mat, card disk, sponge, foam, or matrix is then affixed to the container with a functional barrier that provides a means for O₂ transport. The functional barrier can be of any configuration, provided that it enables isolation of the O₂ scavenging system from the contents of the container. For example, the functional barrier can be, but is not limited to: an inherently gas-permeable polymer; a porous material (e.g., spun-bonded polymer or open cell foam); or, a solid material rendered permeable by perforations. The complete O₂ scavenging system can be placed, positioned, or affixed anywhere within the container to be sealed.

In an analogous manner, when the O₂ scavenging system is used with liquid contents, isolation of the O₂ scavenging composition can be achieved by placing the composition behind a functional barrier that is composed of a polymer film that is permeable to O₂ and water vapor, but not liquid water. Alternatively, the O₂ scavenging system can be applied to one side of a patch or label. Upon drying of the O₂ scavenging composition, the coated surface of the patch or label can be applied to the inside of a container, or a film used to seal a container. Or, in another embodiment, the coated surface of the patch or label can be covered with an O₂ permeable, thin film (e.g., a functional barrier such as Tyvek®) and then the multilayered structure can be affixed to the container.

In other instances, it will be desirable for the patch or label to be affixed to the outside of the container to be sealed. In this case, the patch or label will be applied over a zone of perforations or an alternative site providing a means for O₂ transport from the interior of the container to the exteriorly affixed patch or label and its O₂ scavenging system.

Regardless of the physical placement of the patch or label on the wall or lid of a container, the method for production of the patch or label will be based on conventional means familiar to those skilled in the art of printing, converting or labelmaking (e.g., thermal bonding, heat embossing or lamination using solvent based, transfer, or double-sided adhesives). Likewise, methods of application of a label or patch are conventional and include use of contact adhesive, heat seal adhesive or transfer adhesive, applied using means well-known in the packaging industry (e.g., a cross-web labeler).

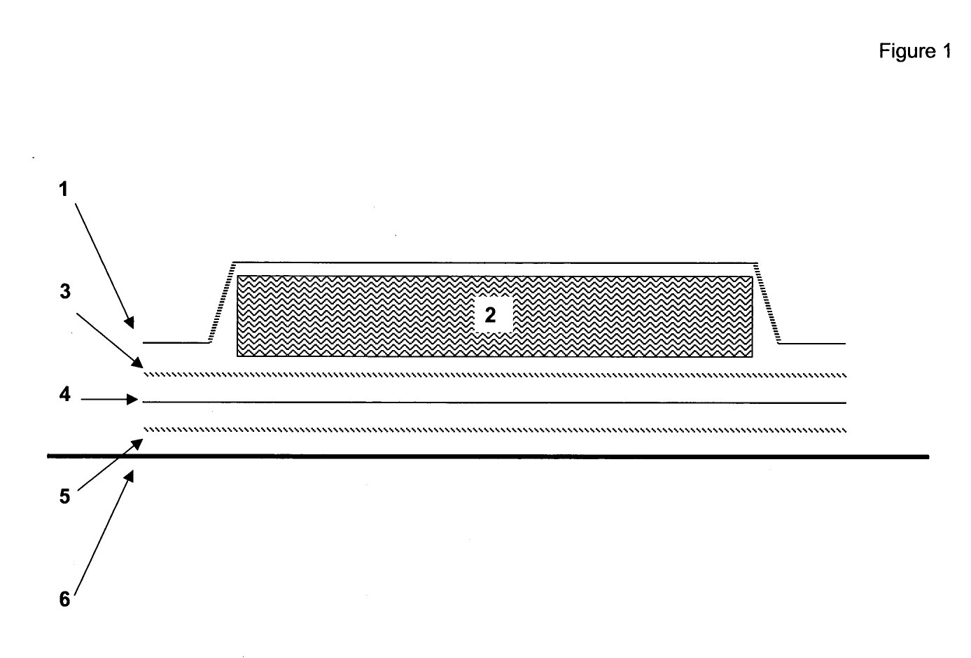

One preferred embodiment is illustrated in FIG. 1. Referring to FIG. 1, a multilayer label suitable for a container comprising a food product is shown that consists essentially of the following layers (wherein the order provided is from the side nearest the food product to the side nearest the exterior of the package): functional barrier membrane (“1”), scavenger layer (“2”) containing the scavenging composition of the invention, adhesive layer (“3”), inter adhesive membrane (“4”), adhesive layer (“5”) and release backing (“6”) (FIG. 1).

As one of skill in the art of packaging is well aware, numerous other examples of patch and label structures are described in the literature (e.g., U.S. Pat. No. 6,139,935), many of which would be suitable for incorporation of the present O₂ scavenging system without undue experimentation.

3. A Film, Coating, Wrap

In another embodiment of the invention, the O₂ scavenging system can be formulated within a polymer matrix that serves to contain the system (and, the matrix may provide a suitable functional barrier, to thereby isolate the O₂ scavenging composition components from the contents of the container). The polymer matrix may be derived from a variety of polymers and formulated as a dispersion, latex, emulsion, plastisol, dry blend or solution. The components can be formulated within the polymer by any method known in the art that does not degrade the components of the O₂ scavenging system and is inert with respect to the contents of the container. Such a polymer matrix can be deposited onto the interior of the container to be sealed as a patch, gasket, coating, or film, for example. The patch, gasket, coating or film may inself embody the functional barrier, or may be covered by a separately applied functional barrier by an additional coating or lamination step. In another embodiment, the system can be combined with a carrier polymer matrix that is applied to shrink wrap film and used to wrap containers.

4. Container Closures

A variety of methods are envisioned to produce components for use in sealing a container (e.g., gaskets, lid liners, caps, corks, plugs).

In one embodiment, the O₂ scavenging composition can be coated or adsorbed onto the surface of a fibrous or sponge substrate and dried. Following coating or laminating with an O₂ permeable polymer that would serve as a functional barrier, the matrix comprising the O₂ scavenging system would be stamped or cut to form disks for use as gaskets or lid liners.

Alternatively, the O₂ scavenging composition is combined with a carrier polymer matrix that is deposited directly on caps or closures to form gaskets or lid liners. The polymer matrix could be deposited by any means suitable in the art, wherein an appropriate quantity of the O₂ scavenging system was deposited to enable sufficient O₂ scavenging (e.g., based on rate and capacity).

In another embodiment, the O₂ scavenging composition can be incorporated directly into the matrix of a cork or plug or the composition can be contained within a reservoir inside the cork or plug. Using these means, the cork or plug could be used to seal a bottle and also enable O₂ scavenging.

Preferred Embodiments of the O₂ Scavenging System

Although the O₂ scavenging system of the present invention is particularly attractive for use in containers comprising food/beverage products as a mechanism to extend the shelf-life of the product (due to the food-safe nature of laccase and ascorbate oxidase and certain reductants) many other applications of the system are envisioned, where an altered gaseous environment is desirable relative to that of untreated air. This includes use of the system: in anaerobic cultures (wherein the O₂ scavenging system could be utilized to create an environment that was anaerobic, thus permitting culture of anaerobic microbes in e.g., petri plates, serum stoppered bottles, gas paks); for preservation of a variety of electronic components/devices (e.g., O₂-sensitive DVDs); for preservation of cosmetics and personal care products (e.g., hand-creams); for inerting aircraft fuel tanks (to prevent flammable fuel/air vapors in fuel tanks); and in packaging of specific pharmaceutical compositions.

### EXAMPLES

The present invention is further defined in the following Examples. These Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various usages and conditions.

General Methods

Unless otherwise indicated below, all materials used in the Examples were obtained from Sigma Chemical Corporation (St. Louis, Mo.).

The meaning of abbreviations is as follows: “sec” means second(s), “min” means minute(s), “h” means hour(s), “d” means day(s), “μl” means microliter(s), “mL” means milliliter(s), “L” means liter(s), “μM” means micromolar, “mM” means millimolar, “M” means molar, “mmol” means millimole(s), “μmole” mean micromole(s), “g” means gram(s), “μg” means microgram(s), “ng” means nanogram(s) and “U” means unit(s).

Laccase Sources and Purification

Laccase from Trametes versicolor was obtained in a crude preparation from Wacker Chemie (München, Germany). The laccase content is approximately 5% by weight. The crude sample at 2 g/40 mL in bis-tris propane buffer (pH 6, 20 mM) was centrifuged for 10 min to remove insoluble material and concentrated >100-fold by ultrafiltration to remove low molecular weight contaminants. About 90% of the protein that remains is laccase as determined by SDS-PAGE and N-terminal sequencing. T. versicolor is known to have genes for at least 8 different laccase proteins. The material used herein was predominately lacIII, the major laccase from this organism. Purified samples were stored as concentrated solutions (3.5 mg/mL) in bis-tris propane buffer and frozen in aliquots of 0.2 mL.

Myceliophthora thermophilia laccase was obtained from Novozymes (Franklinton, N.C.) as DeniLite® II Base (Item #NS37008), 20 which is a preparation sold for use in decolorizing denim cloth. DeniLite® II Base (1 g) was brought to a volume of 10 mL in 50 mM MES pH 5.5 buffer, 1 mM EDTA and resuspended by gentle inversion of the tube for 1 hr at 25° C. The enzyme was supplied on an inert carrier that was sedimented by brief centrifugation. The supernatant contained about 2 mg/mL of protein and 4% ethoxylated fatty alcohol surfactant.

Laccase from Stachybotrys chartarum was supplied by Genencor, (Palo Alto Calif.) at a concentration of 15.4 mg/mL and was of sufficient purity to be used directly.

Laccase from Coriolus hirsutus was supplied by SynectiQ, Dover, N.J. at a concentration of 2.4 mg/mL and was also of sufficient purity to be used directly.

### Example 1

### A Liquid O₂ Scavenging Composition

The present Example describes use of an O₂ scavenging system to effectively scavenge headspace O₂ in a sealed container, herein the system was composed of an O₂ scavenging composition (i.e., laccase and sodium ascorbate) dissolved in water.

Specifically, an O₂ scavenging composition consisting of 640 mg of sodium ascorbate and 0.4 mg of T. versicolor laccase (Wacker Chemie) in 1.5 mL of water was placed into an air-filled bottle fitted with a Qubit Systems (Kingston, Ontario) gas-phase O₂ sensor. The O₂ concentration at room temperature was measured over time. It dropped from an initial value of 20.9% to 3.5% after 58 hr.

### Example 2

### Comparison of Activity of Various Laccases on Paper Strips

The present Example compares O₂ scavenging achieved using a liquid O₂ scavenging composition (i.e., laccase and sodium ascorbate) applied to a paper surface, wherein the activity of laccases from different sources are tested for their applicability.

The protein concentration of laccase from four different sources was determined using the Bio-Rad protein assay (Bio-Rad, Hercules, Calif.), and adjusted to a concentration of 1.25 mg/mL. A solution consisting of 650 μl sodium ascorbate (500 mg/mL in 10 mM MES) and 100 μl of enzyme was made up for each enzyme, and applied to 2.54×7.6 cm strips of Whatman 3MM filter paper (Kent, UK). Each strip was placed in a separate 125 mL jar fitted with a Qubit Systems (Kingston, Ontario) gas phase O₂ sensor.

The O₂ concentration at room temperature was measured over 72 hrs. The identity of the laccases and the final O₂ concentrations are shown in the Table below.

TABLE 1
Remaining O₂ Concentration Using Various Laccases

| | % O₂ |
|---|---|
| Laccase source | Remaining At 72 Hrs |
| Trametes versicolor | 9 |
| Myceliophthora thermophilia | 11 |
| Stachybotrys chartarum | 7 |
| Coriolus hirsutus | 8 |

### Example 3

### Comparison of Activity of Various Non-Ascorbate Reductants on Paper Strips

The present Example compares O₂ scavenging achieved using a liquid O₂ scavenging composition (i.e., laccase and reductant) applied to a paper surface, wherein the activity of different non-ascorbate reductants are tested for their applicability.

Specifically, the reductant activity of a variety of Generally Recognized as Safe (GRAS) reductants were tested below, by mixing laccase and the candidate reductant in a sealed container and measuring the loss of O₂; however, since the GRAS reductants were not water-soluble, it was necessary to first dissolve each in canola oil and then prepare emulsions (using lecithin as a surfactant). Each emulsion thus contained the following components: 200-250 mg of candidate reductant, 500 μl of canola oil, 100 μl lecithin (saturated solution in ethanol), and 100 μl Myceliophthora thermophilia laccase (Novozymes, 0.2-9.5 mg in water). The components were vortexed to form an emulsion and then applied to a 15 cm² piece of Whatman 3MM filter paper (Whatman, Kent, UK) which was placed in a 137 mL jar fitted with a Qubit systems (Kingston, Ontario) gas phase O₂ sensor.

O₂ scavenging was measured at room temperature, atmospheric O₂ and 100% humidity. Results, shown below in Table 2, show the final % O₂ remaining after 20 hr. Control reactions had water substituted for enzyme and showed less than 0.5% removal of O₂ after 20 hr.

TABLE 2
Remaining O₂ Concentration Using Non-Ascorbate Reductants

| | % O₂ Remaining |
|---|---|
| Reductant | At 20 Hrs |
| Butylated hydroxyanisole (BHA) | 13.0 |
| Tertiary-butylated hydroquinone (T-BHQ) | 14.8 |
| Ethoxyquin | 17.3 |
| Propyl gallate | 18.0 |
| Butylated hydroxytoluene (BHT) | 19.8 |

### Example 4

### An O₂ Scavenging System Using a Combination of Reductants On a Paper Strip

The present Example demonstrates an O₂ scavenging system, using a liquid O₂ scavenging composition (i.e., laccase and reductant) applied to a paper surface, wherein the reductant activity is provided by a combination of two substrates (i.e., propyl gallate and calcium ascorbate).

An O₂ scavenging composition was prepared consisting of the following components: 400 mg propyl gallate, 100 mg calcium ascorbate, 600 μl canola oil, 100 μl lecithin (saturated solution in ethanol), and 100 μl Myceliophthora thermophilia laccase (Novozymes, 9.5 mg). The composition was vortexed to form an emulsion and then applied to a 15 cm² piece of Whatman 3MM filter paper (Kent, UK) which was placed in a 137 mL jar fitted with a Qubit systems (Kingston, Ontario) gas phase O₂ sensor.

O₂ scavenging was measured at room temperature, atmospheric O₂ and 100% humidity. After 45 hr, the O₂ level had dropped from 20.9% to 14.5%. In contrast, control reactions had no enzyme added and showed no removal Of O₂.

### Example 5

### Activation of an O₂ Scavenging System by Liquid Water

The present Example describes inactivation and then activation of an O₂ scavenging system, wherein the system was composed of an O₂ scavenging composition (i.e., laccase and sodium ascorbate) applied to a surface of paper.

Filter paper strips (1 cm×5.5 cm of Whatman #4, Kent, UK) carrying the O₂ scavenging composition were wrapped around the interior of a vial. The O₂ scavenging composition consisted of three different volumes of a 3.5 mg/mL solution of purified T. versicolor laccase (Wacker Chemie) applied dropwise and dried in a nitrogen flow at ambient temperature, followed by 250 μl of 100 mM sodium ascorbate in pH 6 phosphate buffer applied dropwise over the same area and dried. The initial O₂ partial pressure was fixed at 6.7%.

The scavenging was initiated by addition of 150 μl of deionized water, and the percentage of O₂ in each vial was measured after 120 min. The data for three different volumes of enzyme solution are shown in Table 3 below. A control with no enzyme produced negligible change in O₂ concentration over the same time period.

TABLE 3
Volumetric Effect Of Laccase On Final O₂ Concentration

| | % O₂ Remaining At |
|---|---|
| Volume laccase | 120 Min |
| 50 μl | 5.9 |
| 250 μl | 4.9 |
| 500 μl | 4.2 |

### Example 6

### Activation of an O₂ Scavenging System by Water Vapor

The present Example describes self-activation of an inactivated O₂ scavenging system, wherein the system was composed of an O₂ scavenging composition (i.e., laccase and sodium ascorbate) applied to a surface of polyester film.

Specifically, 5 mL of an O₂ scavenging composition consisting of 20% sodium ascorbate, 3 mg laccase (DeniLite® II base, Novozymes), and 15% Elvanol® 51-05 polyvinyl alcohol (E.I. duPont de Nemours & Co., Inc., Wilmington, Del.) in 50 mM MES buffer pH 5.5 was spread evenly on a 10×7 cm sheet of 92 gauge Mylar® LBT polyester film (E.I. duPont de Nemours & Co., Inc.) with a #100 wire wound coating rod. The composition was dried at room temperature under a stream of nitrogen. The resulting coated Mylar® strip was placed into a 125 mL bottle that was closed with a cap fitted with a Qubit Systems (Kingston, Ontario) gas phase O₂ sensor. The bottle also contained a piece of filter paper saturated with water to provide a source of high humidity for reactivating the dried O₂ scavenging composition.

The O₂ concentration was measured over time. It dropped from an initial value of 20.9%, eventually stabilizing at a level of 12% after 50 hrs.

### Example 7

### Varying O₂ Scavenging Capacity by Varying the Quantity of Reductant

The present Example demonstrates how the self-activation of an inactivated O₂ scavenging system can be controlled, according to the amount of reductant used in the O₂ scavenging composition.

Various amounts of ascorbate were deposited on 1 cm×5.5 cm strips of Whatman #4 filter paper (Kent, UK) and the O₂ scavenging capacity tested. Specifically, each strip contained 0.2 mg of a freshly prepared laccase solution (5 mg/mL DeniLite® II base (Novozymes) in deionized water (Milli Q system, Millipore, Billerica, Mass.)) and a freshly prepared solution of sodium ascorbate in deionized water as reductant (reductant concentration shown below in Table 4). Strips were dried for 1 hr in a stream of dry N₂.

The paper strips were each loaded into identical 20 mL glass crimp-top vials equipped with septum-sealed sidearms through which an O₂-sensitive electrode (Microelectrodes, Inc., Bedford, N.H.) was inserted. The vial top was sealed with a lyophilization-style rubber stopper and an aluminum crimp top.

The O₂ scavenging system was activated by adding 150 μl of deionized water to the base of the vial via syringe. The paper strips carrying the O₂ scavenging composition were not in contact with the liquid water. O₂ scavenging was measured at room temperature, atmospheric O₂ and 100% humidity. Initial O₂ was 20%. Results, shown below in Table 4, show the final % O₂ remaining after 24 hr.

TABLE 4
Volumetric Effect Of Reductant On Final O₂ Concentration

| | % O₂ Remaining |
|---|---|
| Ascorbate (mg) | At 24 Hrs |
| 40.75 | 19 |
| 81.25 | 17 |
| 162.5 | 12.5 |
| 325 | 7.5 |

### Example 8

### Application of Homogeous and Non-Homogeneous O₂ Scavenging Compositions to a Surface

The present Example compares five different methods of applying an O₂ scavenging composition (i.e., laccase and sodium ascorbate) to a surface of paper. These methods can be generally described as: 1.) dipping in a homogeneous solution; 2.) spraying with a homogenous solution; 3.) dipping with a reductant solution, followed by dropwise addition of an enzyme solution; 4.) spraying with a reductant solution, followed by dropwise addition of an enzyme solution; and 5) dropwise addition of a reductant solution, followed by dropwise addition of an enzyme solution.

Dipping Methods

Filter paper strips (1×5.5 cm, Whatman #4, Kent, UK) comprising an O₂ scavenging composition were prepared, as described below in Table 5. The reductant solution (sol'n) was a freshly prepared solution of sodium ascorbate (1 M) in deionized water (Milli Q system, Millipore, Billerica, Mass.); the enzyme solution was a freshly prepared solution of laccase (5 mg/mL DeniLite® II base, Novozymes) in deionized water; and, the homogeneous solution was a freshly prepared solution of sodium ascorbate (1 M) and laccase (5 mg/mL DeniLite® II base) in deionized water. Strips were dried for 1 hr in a stream of dry N₂.

TABLE 5
Various Dipping Methods For Applying An
O₂ Scavenging Composition To A Surface

| Method | Steps For Preparation |
|---|---|
| “Homogenous Dip” | Immerse in homogeneous sol'n for 5 min; |
| | remove strip from sol'n; dry strip. |
| “Reductant Dip” | Immerse in reductant solution for 5 min; |
| | remove strip from sol'n; dry strip. Add 100 μl of |
| | enzyme sol'n dropwise; dry strip. |
| “Dropwise Control-1” | Add 100 μl of reductant sol'n dropwise; dry |
| | strip. Add 100 μl of enzyme sol'n dropwise; dry |
| | strip. |

Spraying Methods

Filter paper strips comprising the O₂ scavenging composition were prepared in a manner similar to that described above, with the following exceptions: the enzyme solution was 4.3 mg/mL laccase (DeniLite® II base) (versus 5 mg/mL); and, the homogeneous solution was 1 M sodium ascorbate and 4.3 mg/mL laccase (DeniLite® II base) (versus 5 mg/mL). Spraying was conducted by filling the sprayer reservoir of a chromatography sprayer (VWR 21428-350, 10 mL volume) with the appropriate solution, placing a filter paper strip 8 cm from the outlet and exposing the strip to the spray for 5 sec. Table 6 provides a complete summary of the methods used.

TABLE 6
Various Spraying Methods For Applying An
O₂ Scavenging Composition To A Surface

| Method | Steps For Preparation |
|---|---|
| “Homogenous Spray” | Spray with homogeneous sol'n for 5 sec; |
| | remove strip from spray; dry strip. |
| “Reductant Spray” | Spray with reductant sol'n for 5 sec; remove |
| | strip from spray; dry strip. Add 100 μl of |
| | enzyme sol'n dropwise; dry strip. |
| “Dropwise Control-2” | Add 100 μl of reductant sol'n dropwise; dry |
| | strip. Add 100 μl of enzyme sol'n dropwise; dry |
| | strip. |

Measurement of O₂ Scavenging

The paper strips were each loaded into identical 20 mL glass crimp-top vials equipped with septum-sealed sidearms through which an O₂-sensitive electrode (Microelectrodes, Inc., Bedford, N.H.) was inserted. The vial top was sealed with a lyophilization-style rubber stopper and an aluminum crimp top. Two syringe needles are inserted through the stopper and the vial was flushed with N₂ until the O₂ sensor was stable at less than 0.10% (Note: If the syringe needles were capped at this point the O₂ content in the vial was stable). The vials were immersed in a 4° C. bath, and air was added back into the vial to give typically 7% O₂.

The O₂ scavenging system was activated by adding 150 μl of deionized water to the base of the vial via syringe. The paper strips carrying the O₂ scavenging composition were not in contact with the liquid water. The O₂ content in the vial was followed over time. The O₂ content in the vials began to drop within a few hours.

No significant differences in the time-course of O₂ scavenging were observed among the “Homogenous Dip”, “Reductant Dip” and “Dropwise Control-1” strips. In contrast, the “Homogenous Spray” and “Reductant Spray” strips removed O₂ from the vials slightly faster (50% removed in 15 hr) than the “Dropwise Control-2” strip (50% removed in 20 hr).

### Example 9

### Application of an O₂ Scavenging Composition by Draw-Down

The present Example describes a draw-down technique using a wire-wound rod for application of an O₂ scavenging composition (i.e., laccase, reductant and a binder) to a surface of Tyvek®.

Specifically, an O₂ scavenging system was prepared by drawing-down an aqueous solution containing 1.2% hydroxypropyl methyl cellulose (viscosity of 2 wt % solution in H₂O=100,000 cps, Aldrich, St. Louis, Mo.), 14.6% sodium ascorbate (99+%, Aldrich), and 0.36% laccase (DeniLite® II base, Novozymes) on a 5×14 cm piece of Tyvek® 2FS (E. I. duPont de Nemours & Co., Inc., Wilmington, Del.) using a #75 wire-wound rod. The O₂ scavenging composition was dried over night in a vacuum oven at room temperature under a slow purge of nitrogen. The amount of coating on the Tyvek® was found to be 1.9 mg/cm².

Measurement of O₂ Scavenging

The O₂ scavenging system to be tested was placed in a 100 mL media jar fitted with a Qubit Systems (Kingston, Ontario) gas phase O₂ sensor and a 20 mL scintillation vial containing a 1×6 cm strip of filter paper. The jar was flushed with nitrogen to less than 1% O₂ and the O₂ level monitored for at least 1 hr to check for leaks. The jar was then opened to the air and the O₂ level allowed to rise to about 15%. At 15% O₂ and a temperature of 25° C., the 125 mL volume of the jar would contain 770 μM of O₂. Water (1 mL) was placed in the scintillation vial and the jar 35 resealed. The O₂ content of the jar was monitored over time to determine the scavenging ability of the O₂ scavenging system. The rate of O₂ scavenging was taken as the slope of the steepest portion of the O₂ versus time plot, expressed in μmol of O₂ per hr.

Rate of O₂ Scavenging

When the O₂ scavenging system was tested (prepared by the draw-down technique described above), a maximum rate of scavenging of 25.5 μM of O₂ per hr was obtained.

### Example 10

### Application of an O₂ Scavenging Composition by Screen-Printing

The present Example compares a screen-printing technique to a draw-down technique for application of an O₂ scavenging composition (i.e., laccase, reductant mixture, and a binder) in the form of an ink to various surfaces.

The O₂ scavenging composition herein was a high-viscosity, aqueous solution containing: 1.2% hydroxypropyl methyl cellulose, 9.7% sodium ascorbate, 9.7 % ascorbic acid (99% min, Sigma, St. Louis, Mo.), and 0.18% laccase (DeniLite® II base, Novozymes). This ink was applied to either Tyvek® 2FS (E.I. duPont de Nemours & Co., Inc., Wilmington, Del.) or Whatman 3MM filter paper (Kent, UK), using a method of screen-printing or draw-down. Specifically, screen-printing was performed by hand, using a 10×14 inch, 124 mesh, multifilament polyester screen (Speed Ball Art Products, Statesville, N.C.), while drawn-down was performed using a #75 wire-wound rod. All O₂ scavenging compositions were dried over night in a vacuum oven at room temperature under a slow purge of nitrogen.

The O₂ scavenging rate of each O₂ scavenging system was determined as described in Example 9. Results are shown below in Table 7.

TABLE 7
Rate Of O₂ Scavenging Compared Between
Screen-Printed And Drawn-Down Ink

| Application | | Loading | O₂ Scavenging |
|---|---|---|---|
| Method | Surface | (mg/cm²) | Rate (μM/hr) |
| Screen-print | Tyvek ® 2FS | 0.4 | 8 |
| Screen-print | 3 MM paper | 2.8 | 15 |
| Draw-down | Tyvek ® 2FS | 4.7 | 15 |
| Draw-down | 3 MM paper | 5.0 | 26 |

### Example 11

### Comparison of Activity of Various O₂ Scavenging Compositions Coated Onto Different Surfaces

The present Example compares O₂ scavenging achieved using an O₂ scavenging composition (i.e., laccase, sodium ascorbate and various binders) applied to a various surfaces using a draw-down technique.

Solutions of the O₂ scavenging compositions herein were drawn-down using a # 75 wire-wound rod on various sheet surfaces (described in Table 8 below). All O₂ scavenging compositions were dried over night in a vacuum oven at room temperature under a slow purge of nitrogen.

The O₂ scavenging rate of each O₂ scavenging system was determined as described in Example 9. Results are shown below in Table 8.

TABLE 8
Rate Of O₂ Scavenging Compared Between Various O₂ Scavenging Systems

| O₂ Scavenging Solution Composition | | | | | |
|---|---|---|---|---|---|
| Sodium | | | | | |
| Ascorbate | Laccase | | Coating | | |
| Reductant | enzyme | | weight | | Rate |
| (%) | (%) | Binder (%) | (mg/cm²) | Surface | (μM/hr) |
| 23.1 | 0.1 | 18.1 Aqua Stik ® 1120 | 5.9 | paper peel-off label | 13 |
| | | (E. I. duPont de Nemours & Co., Inc.) | | (Avery Dennison, Pasadena, CA) | |
| 24.6 | 0.06 | 4.9 Elvanol ® 70-06 | 1.9 | Bynel ® 3860 co-extrudable adhesive resin | 13 |
| | | (E. I. duPont de Nemours & Co., Inc.) | | (E. I. duPont de Nemours & Co., Inc.) | |
| 24.6 | 0.06 | 4.9 Elvanol ® 70-06 | 2.1 | Appeel ® 2044 lidding sealant | 14 |
| | | (E. I. duPont de Nemours & Co., Inc.) | | (E. I. duPont de Nemours & Co., Inc.) | |
| 30 | 0.05 | 0.6 carboxy methyl cellulose | 5.0 | Sontara ® 8005 spunlaced nonwoven fabric | 16.3 |
| | | (Sigma, St. Louis, MO) | | (E. I. duPont de Nemours & Co., Inc.) | |
| 23.8 | 0.1 | 17.9 Aqua Stik ® 1120 | 6.9 | Mylar ® 300D PET polyester film | 17 |
| | | (E. I. duPont de Nemours & Co., Inc.) | | (E. I. duPont de Nemours & Co., Inc.) | |
| 22.3 | 0.07 | 0.6 carboxy methyl cellulose | 3.8 | Tyvek ® 2FS flash spun polyethylene sheet | 20.5 |
| | | (Sigma, St. Louis, MO) | | (E. I. duPont de Nemours & Co., Inc.) | |
| 30 | 0.05 | 0.6 carboxy methyl cellulose | 8.7 | Sontara ® 8426 spunlaced nonwoven fabric | 25.5 |
| | | (Sigma, St. Louis, MO) | | (E. I. duPont de Nemours & Co., Inc.) | |
| 39.6 | 0.04 | 0.5 carboxy methyl cellulose | 11.7 | Sontara ® 9927 spunlaced nonwoven fabric | 32.3 |
| | | (Sigma, St. Louis, MO) | | (E. I. duPont de Nemours & Co., Inc.) | |
| 30 | 0.05 | 0.6 carboxy methyl cellulose | 6.2 | Sontara ® 8838 spunlaced nonwoven fabric | 34.4 |
| | | (Sigma, St. Louis, MO) | | (E. I. duPont de Nemours & Co., Inc.) | |
| 14.6 | 0.06 | 1.2 hydroxypropyl methyl cellulose | 2.8 | Sontara ® 8801 spunlaced nonwoven fabric | 48.6 |
| | | (Aldrich, St. Louis, MO) | | (E. I. duPont de Nemours & Co., Inc.) | |
| 14.6 | 0.06 | 1.2 hydroxypropyl methyl cellulose | 7.5 | Sontara ® 8429 spunlaced nonwoven fabric | 63.9 |
| | | (Aldrich, St. Louis, MO) | | (E. I. duPont de Nemours & Co., Inc.) | |
| 23.5 | 0.09 | 13.2 Baystal ® S44R SBR latex | 11.7 | GF/A glass fiber filter | 75.8 |
| | | (Bayer Polymers LLC, Pittsburgh, PA) | | (Whatman, Kent, UK) | |
| 23.9 | 0.08 | 8.9 Elvanol ® 70-06 | 5.7 | 3 MM wood fiber filter paper | 79 |
| | | (E. I. duPont de Nemours & Co., Inc.) | | (Whatman, Kent, UK) | |

### Example 12

### Comparison of Activity of O₂ Scavenging Compositions Prepared With Different Polymeric Binders

The present Example compares O₂ scavenging achieved using an O₂ scavenging composition (i.e., laccase, ascorbate and binder) applied to a polymer surface using a draw-down technique, wherein the activity of different binders are tested for their applicability.

Solutions comprising laccase (DeniLite® II base, Novozymes) and ascorbate were prepared with one of seven different binders, as described below in Table 9. Each binder was incorporated into the final O₂ scavenging composition according to the weight percent (wt %) specified in the Table. The O₂ scavenging compositions were then drawn-down on either Tyvek® 2FS (E.I. duPont de Nemours & Co., Inc., Wilmington, Del.) or Mylar® 300D (E.I. duPont de Nemours & Co., Inc.) surfaces using a #75 wire-wound rod. All O₂ scavenging compositions were dried over night in a vacuum oven at room temperature under a slow purge of nitrogen.

The O₂ scavenging rate of each O₂ scavenging system was determined as described in Example 9. Results are shown below in Table 9.

TABLE 9
Rate Of O₂ Scavenging Using Various Polymeric Binders

| O₂ Scavenger Solution Composition | | | | wt % | Coating | | |
|---|---|---|---|---|---|---|---|
| | Laccase | | | binder | weight | | Rate |
| Reductant (wt %) | (wt %) | Binder | Binder Source | in sol'n | (mg/cm²) | Surface | (μM/hr) |
| 32.2 wt % 50/50 sodium | 0.13 | Elvanol ® 51-05 polyvinyl | E. I. duPont de | 9.1 | 5.8 | Tyvek ® | 18.4 |
| ascorbate/ascorbic acid | | alcohol | Nemours & Co., Inc. | | | 2FS | |
| 24.2 wt % sodium | 0.08 | Hydroxypropyl methyl | Aldrich, St. Louis, | 2.6 | 5 | Tyvek ® | 21.8 |
| ascorbate | | cellulose (100,000 cps | MO | | | 2FS | |
| | | viscosity) | | | | | |
| 26.2 wt % sodium | 0.07 | Baystal ® S44R SBR latex | Bayer Polymers LLC, | 11.8 | 6.3 | Tyvek ® | 23.4 |
| ascorbate | | | Pittsburgh, PA | | | 2FS | |
| 24 wt % sodium | 0.07 | Hartex ® 101 natural rubber | Firestone Polymers, | 9.2 | 4.8 | Tyvek ® | 23.9 |
| ascorbate | | latex | Akron, OH | | | 2FS | |
| 26.4 wt % calcium | 0.08 | Carboxy methyl cellulose, | Sigma, St. Louis, MO | 0.6 | 5 | Tyvek ® | 24.4 |
| ascorbate | | sodium salt, high viscosity | | | | 2FS | |
| 18.6 wt % sodium | 0.06 | Michem Prime 2960, | Michelman Inc., | 8.2 | 5.9 | Mylar ® | 29 |
| ascorbate | | dispersion Surlyn ® copolymer | Cincinnati, OH | | | 300D | |
| 23.1 wt % sodium | 0.1 | Aqua Stik ® 1120 waterbased | E. I. duPont de | 27.1 | 6.4 | Tyvek ® | 29 |
| ascorbate | | polychloroprene | Nemours & Co., Inc. | | | 2FS | |

### Example 13

### Activity of Thermally Laminated O₂ Scavenging Systems

The present Example compares the stability of two O₂ scavenging systems that were thermally laminated, wherein one O₂ scavenging composition was inactivated by drying prior to lamination, while the other was moist and active when laminated.

Specifically, two 15 cm² Whatman 3MM filter paper strips were dipped in 1 M calcium ascorbate containing 4.5 mg/mL laccase (DeniLite® II base, Novozymes). One strip was dried at 60° C. and the other was maintained wet. Both strips were placed between a heat seal lidding foil (Appeel®, E.I. duPont de Nemours & Co., Inc., Wilmington, Del.) and a layer of 2FS Tyvek and then heated at 90° C. under pressure for 30 min to bond the sheet material. The resulting O₂ scavenging systems were tested for O₂ scavenging activity by placing them in 137 mL bottles fitted with a Qubit Systems (Kingston, Ontario) gas phase O₂ sensor; a water saturated blotter paper provided 100% humidity in the bottle. Initial conditions were 20.9% oxygen and room temperature.

The dried strip showed a peak O₂ scavenging rate of 0.26% per hr while the wet strip showed only a peak O₂ scavenging rate of 0.06% per hr.

### Example 14

### Long-Term Stability of Inactivated O₂ Scavenging Systems

The present Example compares the activity of a freshly prepared O₂ scavenging system and a comparable O₂ scavenging system that had been dried and stored dry for 11 months, wherein both systems were composed of an O₂ scavenging composition (i.e., laccase and sodium ascorbate) applied to a surface of paper.

Whatman 3MM filter paper strips (Kent, UK; 1×3 inch) were coated dropwise with a 1 M solution of sodium ascorbate containing 0.2 mg laccase (DeniLite® II base, Novozymes). The strips were dried under vacuum for 1 hr and then stored at 30° C. under nitrogen in a sealed box containing dessicant for a period of 11 months.

A control strip was prepared by coating dropwise with a 1 M solution of sodium ascorbate containing 0.2 mg laccase (DeniLite® II base, Novozymes). The strip was dried under vacuum for 1 hr.

The “stored strip” and the “control strip” were each placed in a separate 137 mL bottle containing air at 100% humidity and fitted with a Qubit Systems (Kingston, Ontario) gas phase O₂ sensor. After 120 hr, the O₂ in the bottle with the control strip was 1%, while the O₂ in the bottle with the stored strip was 3%.

### Example 15

### Activation of O₂ Scavenging Systems at Various Humidities

The present Example describes the self-activation of inactivated O₂ scavenging systems at various relative humidities, wherein each system was composed of an O₂ scavenging composition (i.e., laccase and sodium ascorbate) applied to a surface of paper. Based on this analysis, it was possible to determine the humidity threshold for activation of O₂ scavenging.

An O₂ scavenging composition consisting of 198 mg of sodium ascorbate and 0.25 mg of M. thermophilia laccase (Denilite® II base, Novozymes) in 1 mL of water was absorbed by a 2.85×4.11 cm card of Whatman 3MM filter paper (Kent, UK). The card was dried under the flow of nitrogen and, when dry, placed into an empty 20 mL vial inside a 130 mL glass bottle, containing 10 mL of an aqueous sulfuric acid solution (17.9%, 38.4%, or 52.5%). Concentration of the sulfuric acid solution determined the relative humidity (RH) of the system, wherein: a 17.9% solution produces a RH of 90%, a 38.4% solution produces a RH of 60%, and 52.5% solution produces a RH of 30%.

The bottle was closed with a cap equipped with a Qubit Systems Kingston, Ontario) gas phase O₂ sensor and the O₂ concentration (starting at 20.9%) at room temperature over time was measured. Results, shown below in Table 10, show the % O₂ consumed after 68 hr.

TABLE 10
Relative Humidity Effect On Total O₂ Scavenging

| Relative | % O₂ Consumed |
|---|---|
| Humidity (%) | At 68 Hrs |
| 30 | None |
| 60 | 27 |
| 90 | 62 |

The amount of time required for each O₂ scavenging system to “self-activate” was determined by relative humidity. Specifically, no activation was observed at 30% RH, whereas O₂ scavenging began to take place after 18 hr at 60% RH and 9 hr at 90% RH.

### Example 16

### Tuning Activation Time by Varying Reductant

The present Example demonstrates how the self-activation of an inactivated O₂ scavenging system can be controlled, according to the specific reductant used in the O₂ scavenging composition.

Two O₂ scavenging compositions were freshly-prepared, comprising:
(1) 2.5 M sodium ascorbate and 5.3 mg/mL laccase (Denilite® II base, Novozymes) in 50 mM MES pH 5.5 made with deionized water (Milli Q system, Millipore, Billerica, Mass.); or
(2) 1.25 M calcium ascorbate and 5.3 mg/mL laccase (Denilite® II base) in 50 mM MES pH 5.5 made with deionized water (Milli Q system).
   The O₂ scavenging composition (0.75 mL) was deposited dropwise onto filter paper strips (1 in×3 in, Whatman 3MM, Kent, UK) and dried for 1 hr in a stream of dry N₂. Each strip contained an equivalent loading of ascorbate and laccase but differed in the nature and loading of the cation.

The O₂ scavenging performance of the paper strips was tested by loading each strip into identical 137 mL test jars equipped with a Qubit Systems (Kingston, Ontario) gas phase O₂ sensor fitted into the screw cap. In the base of each bottle was a water-saturated disk of Whatman 3MM filter paper. The bottles were placed in a chamber held at 4° C., and the O₂ content in both bottles was monitored continuously. The initial O₂ concentration in each bottle was 21%. Results are shown below in Table 11.

TABLE 11
Relative Humidity Effect On Total O₂ Scavenging

| | Time (Hr) To 20% | % O₂ Remaining |
|---|---|---|
| Reductant | O₂ Concentration | At 20 Hr |
| Sodium ascorbate | 10 | 14 |
| Calcium ascorbate | 5 | 16.6 |

### Example 17

### An O₂ Scavenging System in a Bottle Cap Liner

The present Example describes use of an O₂ scavenging system, wherein the system was composed of an O₂ scavenging composition (i.e., laccase and calcium ascorbate) applied to a surface of paper the size of a bottle cap, the paper was adhered to the cap of a 1 L bottle, and wherein the system was tested for activity when the bottle was filled with beer.

Specifically, a penny-size diameter filter-paper disc of Southern blotting paper (VWR International, West Chester, Pa.) was affixed to the inner side of a bottle cap with silicone adhesive. The paper weighed 0.217 g when dry, while the weight was 1.012 g when wet (thus, the water capacity of the paper was 0.795 g). After the adhesive had cured, 700 μl of an O₂ scavenging composition (comprising 4 mL of 500 mg/mL calcium ascorbate in water and 300 μl Denilite® II base, Novozymes) was applied to the paper disc.

Two Qubit Systems (Kingston, Ontario) gas phase O₂ sensors were pre-incubated in nitrogen. Beer (750 mL) was poured into each of two 1 L PET soda bottles and allowed to settle, resulting in 250 mL headspace. One bottle was closed with a cap containing the O₂ scavenging system described above, while the “control” bottle was closed with a plain cap (nitrogen gas was used to 20 bring the atmosphere in each bottle to about 5% O₂ prior to capping). After 14 days, the O₂ level was reduced to 0% in the bottle containing the O₂ scavenging system, while the O₂ level in the control bottle was 4.2%.

### Example 18

### An O₂ Scavenging System in a Juice Jug

The present Example describes use of an O₂ scavenging system, wherein the system was composed of an O₂ scavenging composition (i.e., laccase and sodium ascorbate) applied to a surface of paper, the paper was applied to an adhesive-backed metal cap-sealing film and wherein the system was inserted into a plastic jug.

A 2.84 L plastic jug containing orange juice was purchased locally. The juice was removed and the jug was flushed with water several times. The jug was refilled with 2.5 L of water. The O₂ pressure in the vapor space of the jug was fixed by flowing nitrogen through the screw cap opening and monitoring with an O₂ microelectrode (MI-730, Microelectrodes, Inc., Bedford, N.H.) suspended in the headspace. The headspace was flushed with nitrogen to give an O₂ concentration below 6%. The O₂ scavenging composition was prepared from 1.3 mL of laccase (DeniLite® II base, Novozymes) at 2 mg/mL, and 8.7 mL of sodium ascorbate at 500 mg/mL (Sigma), both in 50 mM MES pH 5.5 buffer, 1 mM EDTA. 10 mL of the mixture was applied dropwise uniformly over a 20×12.5 cm sheet of Whatman 3MM filter paper (Kent, UK). The paper was dried under vacuum at ambient temperature for 45 min. Two disks of the dried paper, each about 6.5 cm² in area were attached to the adhesive side of a square of a hot melt adhesive backed metal foil (Appeel® 1181, E. I. du Pont de Nemours & Co., Inc., Wilmington, Del.). The paper disks were attached to the inside surface of the foil using double-sided tape before the foil was used to reseal the opening. The paper disks were dampened with two drops of deionized water before resealing. The seal was made by applying a heated plate to the back of the foil.

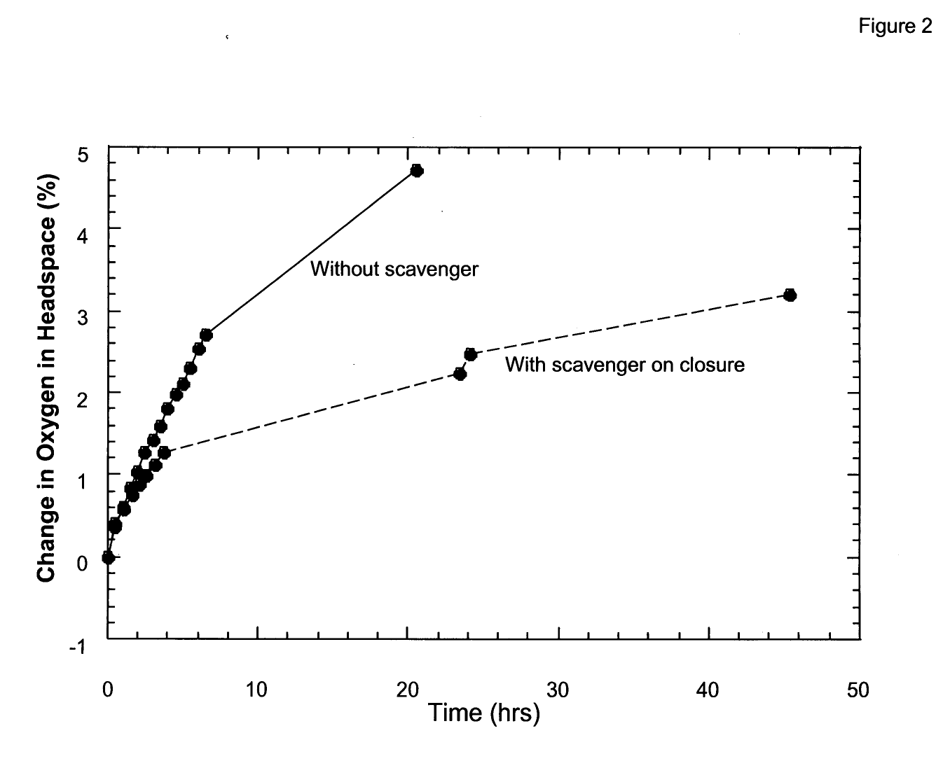

A PBI Dansensor Checkmate 9900 instrument (Scan American Corporation, Kansas City, Mo.) was used to sample the O₂ content in the headspace of the resealed container periodically by inserting a needle through an adhesive-backed septum attached to the jug near the base of the cap. The effect of the scavenger on the headspace O₂ partial pressure is shown in FIG. 2.

### Example 19

### An O₂ Scavenging System in a Sealed Vacuum-Formed Pasta Package

The present Example describes use of an O₂ scavenging system, wherein the system was composed of an O₂ scavenging composition (i.e., laccase and sodium ascorbate) applied to a surface of paper and wherein the system was inserted into a sealed vacuum-formed pasta package.

An O₂ scavenging composition consisting of 3 g sodium ascorbate and 0.5 mg T. versicolor laccase (Wacker Chemie) in 7 mL of 50 mM pH 5.5 MES buffer was absorbed by a 15×8 cm card of Whatman 3MM filter paper (Kent, UK). The paper was sealed into an empty 900 mL vacuum-formed pasta package by reclosing the top with a heat sealer. The package was fitted with a Qubit Systems (Kingston, Ontario) gas phase O₂ sensor and the O₂ concentration at room temperature was measured over time. It dropped from an initial value of 20.9%, stabilizing at 0% after 40 hrs.

### Example 20

### An O₂ Scavenging System in the Form of a Sachet

The present Example describes use of an O₂ scavenging system, wherein the system was composed of an O₂ scavenging composition (i.e., laccase, sodium ascorbate and fructose) applied to a surface of paper and wherein the composition was inserted into a sachet.

Laccase on clay granules (1 g) was ground with a mortar and pestle, then combined with 3 g of sodium ascorbate and 1 g of fructose, and intimately mixed by further grinding. The mixture was placed into a 2.54×7.6 cm Tyvek® (E. I. duPont de Nemours & Co., Inc., Wilmington, Del.) pouch and sealed with a woodburner. A control mixture containing 3 g of ascorbate and 1 g of fructose was similarly ground and placed in a Tyvek® pouch. The pouches were placed in a 125 mL jar fitted with a Qubit Systems (Kingston, Ontario) gas phase O₂ sensor. Humidity to activate the scavenging was provided by placing a 2.54 cm² square of blotting paper saturated with water in the bottom of the jars. The O₂ concentration at room temperature was measured after 72 hrs. The control showed a reduction of O₂ from 20.9% to 18%, while the O₂ scavenging system showed a reduction from 20.9% to 1.5%.

### Example 21

### High Humidity Activation of an O₂ Scavenginq System Prepared With Ascorbate Oxidase

The present Example describes self-activation of an inactivated O₂ scavenging system, wherein the system was composed of an O₂ scavenging composition (i.e., ascorbate oxidase and calcium ascorbate) applied to a surface of paper.

A solution comprising an O₂ scavenging composition was prepared as follows: ascorbate oxidase (60 units/mg, Item #70-6071-01, Genzyme Diagnostics, Cambridge, Mass.) was added to a 1 M solution of calcium ascorbate, for a final concentration of 4.5 mg/mL. A Whatman 3MM filter paper strip (Kent, UK; 0.75×2.5 inches) was dipped in the O₂ scavenging composition and then dried under a stream of room temperature nitrogen.

The dried strip was placed in a 137 mL bottle containing air at 100% humidity and fitted with a Qubit Systems (Kingston, Ontario) gas phase O₂ sensor. There was no removal of O₂ for the first 5 hr. Reactivation began at 6 hr and the reaction proceeded to remove O₂ to a final concentration of 16.3% after 24 hr.

1. An oxygen scavenging system comprising:
a) an oxygen scavenging composition comprising:
i) an effective amount of laccase enzyme; and
ii) an effective amount of a reducing substrate; and
b) a functional barrier permeable to oxygen.

2. An oxygen scavenging system according to claim 1 wherein the laccase is in an inactive state.

3. An oxygen scavenging system according to claim 2 wherein the laccase is inactivated by a method selected from the group consisting of: drying and freezing.

4. An oxygen scavenging system according to claim 1 wherein the laccase is isolated from fungi.

5. An oxygen scavenging system according to claim 4 wherein the laccase is isolated from a fungus selected from the group consisting of: Trametes versicolor, Myceliophthora thermophilia, Stachybotrys chartarum, Coriolus versicolor and Coriolus hirsutus.

6. An oxygen scavenging system according to claim 1 wherein the laccase is produced recombinantly.

7. An oxygen scavenging system according to claim 1 wherein the reducing substrate is selected from the group consisting of: butylated hydroxyanisole, ascorbic acid, isoascorbic acid, sodium ascorbate, syringaldazine, 2,2′-azinobis(3-ethylbenzothiazoline-6-sulfonate), calcium ascorbate, sodium sulfite, propyl gallate, ethoxyquin,butylated hydroxyanisole and mixtures thereof.

8. An oxygen scavenging system according to claim 7 wherein the reducing substrate is selected from the group consisting of: a combination of sodium ascorbate and calcium ascorbate, and a combination of sodium ascorbate and ascorbic acid.

9. An oxygen scavenging system according to claim 1 wherein the reducing substrate is frozen or dried.

10. An oxygen scavenging system according to claim 1 wherein the reducing substrate is water soluble or lipid soluble.

11. An oxygen scavenging system according to claim 1 wherein the system optionally comprises a material selected from the group consisting of: a polymeric binder, a buffer, a hygroscopic agent and an inert filler.

12. An oxygen scavenging system according to claim 11 wherein the binder is selected from the group consisting of: dispersions of neoprene, styrene butadiene rubber, Surlyn®, vinyl acetate ethylene copolymer, natural rubber, solutions of poly vinyl alcohol, carboxymethyl cellulose, hydroxypropyl methyl cellulose and soy protein.

13. An oxygen scavenging system according to claim 11 wherein the hygroscopic agent is selected from the group consisting of: fructose, silica gel, polyvinyl alcohol, ascorbate and metallic salts.

14. An oxygen scavenging system according to claim 1 wherein the functional barrier is a solid material

15. An oxygen scavenging system according to claim 1 wherein the functional barrier is a gaseous material.

16. An oxygen scavenging system according to claim 14 wherein the solid functional barrier is a polymeric material.

17. An oxygen scavenging system according to claim 15 wherein the gaseous functional barrier is air.

18 An oxygen scavenging system according to claim 14 wherein the functional barrier is in a form selected from the group consisting of: films and matrices.

19. An oxygen scavenging system according to claim 16 wherein the polymeric material is selected from the group consisting of: polyacrylonitrile, polymethacrylonitrile, polyvinylidene chloride, polyethylene, terephthalate, Nylon 6®, polyvinyl chloride, polyethylene, cellulose acetate, cellulose acetate butyrate, cellulose diacetate, polycarbonate, polystyrene, Neoprene®, Teflon®, poly 4-methyl pentene-1 and poly dimethyl siloxane.

20. An oxygen scavenging system according to claim 11 wherein the filler is selected from the group consisting of: microgranular cellulose, ground molecular sieve, carbon black, graphite, clay, wood pulp and activated carbon.

21. A composition comprising:
a) a material selected from the group consisting of: wood pulp filter paper, glass fiber filter paper, paperboard, fabric, nonwoven fabrics, polymer films and label stock, polymeric materials, a mat, a card, a disk, a sponge, polymeric foam; and
b) a matrix comprising the oxygen scavenging system of claim 1.

22. The composition according to claim 21 wherein the oxygen scavenging system is applied to the material as a homogenous composition, as a binary system, or as separate layers

23. The composition according to claim 22 wherein oxygen scavenging system is applied to the material by a method selected from the group consisting of: spreading by wire-wound coating rod, rotary screen printing, flexographic printing, spraying, blotting, dipping, coating and ink jetting.

24. An ink comprising the oxygen scavenging system of claim 1.

25. A sealed container comprising the oxygen scavenging system of claim 1.

26. A sealed container according to claim 25 comprising an insert within the container, wherein the insert comprises the oxygen scavenging system of claim 1.

27. A sealed container according to claim 26 wherein the insert is a form selected from the group consisting of a liner, a card, a sachet, a pouch, an envelope, a canister, a vial, a packet, a label, a patch, a decal, a gasket, a lid, a cap, a cork and a plug.

28. A label comprising the oxygen scavenging system of claim 1 and having a structure as shown in FIG. 1.

29 A sealed container comprising the oxygen scavenging system of claim 1, wherein the oxygen scavenging system is directly incorporated into the walls of the container.

30. A sealed container according to claim 29 wherein the oxygen scavenging system is comprised with a material selected from the group consisting of: laminated films, coated films, laminated paperboard and extrusion coated paperboard.

31. A sealed container according to claim 30 wherein the oxygen scavenging composition is comprised within a polymer matrix.

32. The oxygen scavenging system of claim 31 wherein the polymer matrix is in a form selected from the group consisting of: a dispersion, a latex, an emulsion, a plastisol, a dry blend and a solution.

33. A method for removing oxygen from a sealed container comprising:
a) providing a sealed container having contents;
b) providing an oxygen scavenging system comprising:
i) an oxygen scavenging composition comprising:
1) an effective amount of laccase enzyme; and
2) an effective amount of a reducing substrate;
ii) a functional barrier permeable to oxygen;
wherein the functional barrier serves to sequester the contents of the container from the oxygen scavenging system; and
c) contacting the contents of the sealed container with the oxygen scavenging system whereby oxygen is removed from the sealed container.

34. A method according to claim 33 wherein the contents are selected from the group consisting of: foods, beverages, electronic components, cosmetics and personal care products, and pharmaceuticals.

35. A method according to claim 33 wherein the oxygen scavenging system is provided in an inactive state and is activated coincident with contacting the contents.

36. A method according to claim 33 wherein the oxygen scavenging system is provided in an inactive state and is activated after contacting the contents.

37. A method according to either of claims 35 or 36, wherein the oxygen scavenging system is inactivated by a method selected from the group consisting of: drying and freezing.

38. A method according to either of claims 35 or 36, wherein the inactivated oxygen scavenging composition is activated by a method selected from the group consisting of: contact with liquid water, thawing and adsorption of water vapor.

39. A method according to claim 33 wherein the reducing substrate is selected from the group consisting of: butylated hydroxyanisole, ascorbic acid, isoascorbic acid, sodium ascorbate, syringaldazine, 2,2′-azinobis(3-ethylbenzothiazoline-6-sulfonate), calcium ascorbate, sodium sulfite, propyl gallate, ethoxyquin,butylated hydroxyanisole and mixtures thereof.

40. A method according to claim 39 wherein the reducing substrate is a combination of sodium ascorbate and calcium ascorbate.

41. A method according to claim 33 wherein the reducing substrate is frozen or dried.

42. A method according to claim 33 wherein the reducing substrate is water soluble or lipid soluble.

43. A method according to claim 33 wherein the oxygen scavenging system optionally comprises a material selected from the group consisting of: a polymeric binder, a buffer, a hygroscopic agent and a filler.

44. A method according to claim 43 wherein the binder is selected from the group consisting of: dispersions of neoprene, styrene butadiene rubber, Surlyn®, vinyl acetate ethylene copolymer, natural rubber, solutions of poly vinyl alcohol, carboxymethyl cellulose, hydroxypropyl methyl cellulose and soy protein.

45. A method according to claim 43 wherein the hygroscopic agent is selected from the group consisting of: fructose, silica gel, polyvinyl alcohol, ascorbate and metallic salts.

46. A method according to claim 33 wherein the functional barrier is a solid material.

47. A method according to claim 33 wherein the functional barrier is a gaseous material.

48. A method according to claim 46 wherein the solid functional barrier is a polymeric material.

49. A method according to claim 47 wherein the gaseous functional barrier is air.

50. A method according to claim 46 wherein the functional barrier is in a form selected from the group consisting of: films and matrices

51. A method according to claim 48 wherein the polymeric material is selected from the group consisting of: polyacrylonitrile, polymethacrylonitrile, polyvinylidene chloride, polyethylene, terephthalate, Nylon 6®, polyvinyl chloride, polyethylene, cellulose acetate, cellulose acetate butyrate, cellulose diacetate, polycarbonate, polystyrene, Neoprene®, Teflon®, poly 4-methyl pentene-1 and poly dimethyl siloxane.

52. A method according to claim 43 wherein the filler is selected from the group consisting of: microgranular cellulose, ground molecular sieve, carbon black, graphite, clay, wood pulp and activated carbon.

53. A method according to claim 33 wherein the oxygen scavenging system is comprised within a material selected from the group consisting of: wood pulp filter paper, glass fiber filter paper, paperboard, fabric, polymeric materials, a mat, a card, a disk, a sponge, polymeric foam and a matrix.

54. A method according to claim 53 wherein the oxygen scavenging composition is applied to the material as a homogenous composition, as a binary system, or as separate layers.

55. A method according to claim 54 wherein the oxygen scavenging composition is applied to the material by a method selected from the group consisting of: spreading by wire-wound coating rod, rotary screen printing, flexographic printing, spraying, blotting, dipping, coating and ink jetting.

56. A method according to claim 33 wherein the oxygen scavenging composition is comprised within the walls of the sealed container.

57. A method according to claim 33 wherein the oxygen scavenging composition is comprised within an insert in the sealed container.

58. A method according to claim 57 wherein the insert is in a form selected from the group consisting of a liner, a card, a sachet, a pouch, an envelope, a canister, a vial, a packet, a label, a patch, a decal, a gasket, a lid, a cap, a cork and a plug.

59. An oxygen scavenging system comprising:
a) an oxygen scavenging composition comprising:
i) an effective amount of ascorbate oxidase enzyme; and
ii) an effective amount of a reducing substrate; and
b) a functional barrier permeable to oxygen;
wherein the ascorbate oxidase is in an inactive state and wherein the inactivated oxygen scavenging composition is activated by a method selected from the group consisting of: thawing and adsorption of water vapor.

60. An oxygen scavenging system according to claim 59, wherein the ascorbate oxidase enzyme is isolated from an organism selected from the group consisting of: plants and fungi.
